(19) United States
(12) Patent Application Publication
(10) Pub. No.: US 2025/0264122 A1
(43) Pub. Date: Aug. 21, 2025

(54) SYSTEMS, ARTICLES AND METHODS TO LOOSELY ATTACH, AND SUBSEQUENTLY DETACHABLY FIX, PANELS TO SUBSTRATES WITH SELF-ALIGNMENT OF THE PANELS

(71) Applicant: STELLER INNOVATIONS, LLC, Tyrone, PA (US)

(72) Inventor: Evan Jon Stover, Tyrone, PA (US)

(21) Appl. No.: 19/054,249

(22) Filed: Feb. 14, 2025

Related U.S. Application Data
(60) Provisional application No. 63/554,567, filed on Feb. 16, 2024.

(51) Int. Cl. F16B 5/06; E04F 13/08; F16B 2/20

(52) U.S. Cl. CPC F16B 5/0607; E04F 13/0801; F16B 2/20

(57) ABSTRACT

A system loosely attaches, and subsequently detachably fixes, panels to substrates with self-alignment of the panels. A clip has a base, arm and bearing surface. A portion of the arm delineates a part of an opening of a pocket with an opening. When not locked, the arm is elastically moveable between a first configuration where the opening has a first size and a second configuration where the opening has a second size. Application of a counteracting normal force to the bearing surface locks the arm in the second configuration. When the arm is locked, the panel is loosely held, free to pivot but with the leading portion of the engagement feature unable to be withdrawn from the pocket. The panel can subsequently be removably locked in place in an assembly of panels.

### TECHNICAL FIELD

This application relates generally to the field of building construction, and more specifically to a systems, articles and methods to loosely attach, and subsequently detachably fix, panels to substrates (e.g., plywood, oriented strand board, dimensional lumber) with self-alignment of the panels. Such can, for example, take the form of a cladding system that includes complementary fastening clips and a related construction or assembly method and, or a disassembly method using the same.

### BACKGROUND

In modern construction, the visible interior and exterior surface of a structure is seldom related to the structural material comprising the building. Cladding is a term given to materials and/or systems used to form visible surfaces. The primary function of cladding is to cover the structural, mechanical, and electrical elements of the building. This coverage provides concealment and protection for the underlying materials, components, and structure.

Modern cladding assemblies are composed of a series of panels in either an abutting or overlapping arrangement. These arrangements are disposed upon primarily planer support surfaces with varying orientation (horizontal to vertical including all overhung variants) depending on application. Cladding assembly systems must be capable of providing secure attachment to the underlying structure that overcomes the array of forces exerted on the system (e.g., gravity, wind load, material effects due to environmental changes, and material changes due to age and weathering).

Cladding systems can generally be divided into three classes:
Fastened panel assemblies-comprising individual panels affixed to their support surface solely through the use of traditional fasteners (e.g., nails, screws, and/or adhesives), resulting in a conglomerate surface.
Interlocked panel assemblies-comprising a plurality of panels configured to adjoin the adjacent panels forming an interconnected sheet wherein each individual panel is affixed to the support surface through the use of traditional fasteners.
Hung panel assemblies-comprising a two component system consisting of panel component and mounting component. The mounting component secures, orientates, and links adjacent panel components; in these systems only the mounting elements are affixed to the support surface.

The current market is still dominated by “traditional” fastened panel assemblies and interlocked panel assemblies due to their low cost and increased ease and speed of installation respectively. These systems rely on traditional fastening methods (e.g., nails, screws, and/or adhesives) to secure panels to the support surface (e.g., underlying substrate). Removal of traditional fasteners is extremely time consuming and has a high risk of damaging the cladding and underlying support surfaces (e.g., underlying substrate) rendering them unsuitable for further use.

Cladding systems are one of the most frequently replaced elements of modern structures due to their aesthetic significance and exposure to wear. In addition, their positioning as typically the outermost layer of the building composite, requires removal of the cladding in order to assess, alter, or repair the underlying structural elements. The traditional short life of cladding systems caused market pressures to select low cost thin panel components that exhibit inferior qualities (e.g., low insulation, low noise reduction, low rigidity/load bearing, and low damage resistance).

The rise of the green building initiative highlights the need for products that result in less waste and longer life cycles. This new construction mindset promotes technologies that better utilize a structure's large surface area to enhance its performance and/or provide additional services (e.g., power generation, weather resistance, climate control, and ecosystem services). The drawback to incorporating features such as photovoltaic elements (e.g., solar panels, solar cells, solar arrays) into cladding systems is the increased need to maintain or replace individual components without disturbing extensive sections of the cladding matrix. Similar drawbacks exist for other solar heat collector (e.g., panels with tubes transporting a heat conducting fluid).

The incorporation of these features into cladding is best suited to hung panel assemblies. These hung panel assemblies provide many of the same benefits offered by interlocked panel assemblies (ease and speed of installation) as well as providing the added space and support needed to utilize thicker rigid panel components of higher quality. These more robust panel components serve as better more cost effective platforms for integrating the desired features and technology. Current hung panel assembly designs lack traditional fasteners securing each individual panel, which has caused designers to focus on secure attachment through heavy reliance on barbs and other such unidirectional fasteners. These design choices make it apparent that there is an assumed dichotomy between secure attachment and ease of removal. To achieve the full potential of hung panel cladding in the green building market, a secure attachment system would need to be developed that also permits demounting or disassembly of individual cladding components without damage to the components or underlying substrate, making it easy to remove, repair, replace, and reuse said components.

### SUMMARY

Various embodiments and implementations provide a system, article and methods to loosely attach, and subsequently detachably fix, panels to substrates (e.g., plywood, oriented strand board, dimensional lumber) with self-alignment of the panels. The systems, articles and methods can employ one or more mounting components, typically in the form of one or more clips. The systems, articles and methods advantageously provide a reversible dynamic latching system with the secure attachment (i.e., lock) typical of a unidirectional fastener, yet advantageously, enables the dismounting or disassembly of individual components (e.g., panels, photovoltaic array panels, solar collector panels, steps or stair treads) without destruction of or damage to the clips, the individual components or underlying structure (e.g., substrate, dimensional lumber), making it easy to remove, repair, replace, and reuse said components as well as alter building aesthetics or make repairs to the underlying structure.

In at least some implementations, a clip has a base, an arm and a bearing surface, the base fixable to a first substrate, a portion of the arm delineates a part of an opening of a pocket along with at least one of another portion of the clip or one or more portions of the first substrate, the other portion of the clip or the one or more portions of the first substrate opposed across the opening from the portion of the arm which delineates the part of the opening at least when the clip is mounted to the first substrate, when the arm is not locked in place the arm is elastically moveable between a first configuration in which the opening has a first dimension having a first size and a second configuration in which the first dimension of the opening has a second size, the second size larger than the first size, and wherein the bearing surface locks the arm in place in the first configuration via a counteracting normal force that inhibits movement of the arm toward the second configuration when the bearing surface is engaged to prevent withdrawal of a leading portion of an engagement feature from the pocket through the opening, wherein before the bearing surface is engaged the arm is free to pivot in two directions, and wherein the clip loosely retains the first panel with the leading portion of the engagement feature received in the pocket until the first panel is locked in place.

In some implementations, the engagement feature extends from a first panel.

In some implementations, an adjacent panel that is successively adjacent the first panel, has a rigid counteracting surface that effectively limits travel of the first arm of the first clip to fix the first arm in place once the second panel engages an attachment structure of the first clip, the rigid counteracting surface of the successively adjacent panel filling a space into which a portion of the first clip would deflect in moving to the second configuration and thus preventing such movement, or otherwise applying a normal force to the bearing surface of the first clip. Thus, the first panel is initially loosely held by the first clip, for instance with the leading portion of the engagement feature securely held by the first clip, and with the first panel free to rotate relative to the first clip and substrate until the first panel is locked in place via a subsequent action.

In other implementations, the first panel has a rigid counteracting surface that effectively limits travel of the first arm of the first clip to fix the first arm in place once the first panel engages an attachment structure of the first clip, the rigid counteracting surface of the first panel filling a space into which a portion of the first clip would deflect in moving to the second configuration and thus preventing such movement, or otherwise applying a normal force to the bearing surface of the first clip. Thus, the first panel is initially loosely held by the first clip, for instance with the leading portion of the engagement feature securely held by the first clip, and with the first panel free to rotate relative to the first clip and substrate until the first panel is locked in place via a subsequent action.

In at least some implementations, the base, the connection wall and the arm of the first clip form the pocket that is closed in three directions and is open in a fourth direction toward the opening. In at least some implementations, the base has a protuberance and the arm has a protuberance, the protuberance of the arm opposed across the opening from the protuberance of the base.

In at least some implementations, the connection wall and the arm and the portion of the first substrate form a pocket that is closed in three directions and is open in a direction of the opening. In at least some implementations, the arm has a protuberance, the protuberance of the arm opposed across the opening from the portion of the first substrate.

In at least some implementations, the arm of the first clip, the portion of the first substrate, and another portion of the first substrate form a pocket that is closed in three directions and is open in a forth direction toward the opening. In at least some implementations, the arm of the first clip has a protuberance, the protuberance of the arm opposed across the opening from the other portion of the first substrate.

In at least some implementations, the arm of the first clip is elastically deformable when the arm is not locked in place.

In at least some implementations, the connection wall is elastically deformable when the arm of the first clip is not locked in place.

In at least some implementations, the first clip further includes an attachment structure sized to securely receive a portion of a second panel, the first clip which removably or detachably secures the second panel to the first clip. In at least some implementations, the attachment structure comprises a finger of the first clip (e.g., upstanding finger) and an opposed portion of the first clip, the opposed portion of the first clip opposed from the finger to form a gap therebetween, the gap sized to securely removably receive a portion of the second panel therein via a snap-fit interference or a press-fit interference. In at least some implementations, the opposed portion of the first clip comprises the bearing surface which is a surface of the arm of the first clip. In at least some implementations, the opposed portion of the first clip comprises the bearing surface which is a surface of the connection wall of the first clip. In at least some implementations, the finger of the first clip is an upstanding finger that that extends substantially perpendicular to the base and which has an arcuate profile to engage a lip of the portion of the second panel. In at least some implementations, the finger of the first clip is a horizontally extending finger that extends substantially parallel with the base of the first clip.

In at least some implementations, the leading portion of the engagement feature has a dimension that corresponds to the first dimension, a size of the dimension of the leading portion of the engagement feature is larger than the first size of the first dimension of the opening, and wherein the arm moves from the first configuration to the second configuration to receive the leading portion of the engagement feature through the opening and then returns to the first configuration to loosely (e.g., pivotally) retain the first panel with the arm is locked in place via the counteracting normal force that inhibits movement of the arm and which subsequently fixedly secures the first panel when the first panel is locked in place via attachment of a second panel to the clip or alternatively via an second attachment of the first panel to the first clip at a second portion of the first clip. In at least some implementations, the engagement feature extends from the first panel. In at least some implementations, the first panel and the second panel, the second panel identical to the first panel in shape and size, the first and the second panels comprising one of: i) a pair of exterior cladding panels, a pair of solar panels, or a pair of step treads. In at least some implementations the engagement feature can include a bend spaced inwardly of and proximate the leading portion that increases a range of angular motion of the engagement feature.

In at least some implementations, the base has at least one aperture sized to receive a fastener to secure the clip to the first substrate, and the first substrate comprises one of: i) a piece of dimensional lumber, ii) a piece of sheathing, iii) a metal stud, or iv) a piece of a framework.

In at least some implementations, further comprising: an adhesive that secures the clip to the first substrate.

In at least some implementations, the bearing surface locks the arm in place in the first configuration when the bearing surface is engaged by a portion of a second panel. In at least some implementations, the bearing surface locks the arm in place in the first configuration when the bearing surface is engaged by a surface of the first panel.

In at least some implementations, at least one inside dimension of the pocket is larger than the leading portion of the engagement feature.

In at least some implementations, a method to loosely attach, and subsequently detachably fix, panels to substrates with self-alignment of the panels, includes attaching a first clip to a first substrate, the first clip having a base, an arm and a bearing surface, the base fixable to the first substrate, a portion of the arm of the first clip delineating a part of an opening along with at least one of another portion of the first clip or one or more portions of the first substrate, the other portion of the first clip or the one or more portions of the first substrate opposed across the opening from the portion of the arm which delineates the part of the opening at least when the first clip is mounted to the first substrate, when not locked in place the arm is elastically moveable between a first configuration in which the opening has a first dimension having a first size and a second configuration in which the first dimension of the opening has a second size; inserting a leading portion of an engagement feature of a first panel through the opening and in to a pocket, the pocket which is closed in three directions and open in a fourth direction toward the opening and the arm remaining unlocked and movable in at least two opposed directions until the arm is locked in place; and engaging a bearing surface of the first clip to lock the arm in place in the first configuration via a counteracting normal force that inhibits movement of the arm toward the second configuration when the bearing surface is engaged whereby the first clip loosely holds the first panel, the first panel able to pivot with respect to the first clip and, or the substrate but the first panel not able to be withdrawn from the first clip.

In at least some implementations, engaging the bearing surface of the first clip to lock the arm in place in the first configuration can include attaching a second panel to the first clip to engage the bearing surface of the first clip to lock the arm of the first clip in the first configuration.

In at least some implementations, attaching the second panel to the first clip can include snapping a portion of the second panel into an attachment structure of the first clip.

In at least some implementations, attaching the second panel to the first clip can include leveraging a portion of the second panel into the first clip.

In at least some implementations, engaging the bearing surface of the first clip to lock the arm in place in the first configuration can include pressing a distal end of the first panel toward the first clip to engage the bearing surface of the first clip to lock the arm of the first clip in the first configuration.

In at least some implementations, attaching the first clip to the first substrate can include attaching the first clip to a piece of dimensional lumber or sheathing of a wall or a ceiling. In at least some implementations, engaging the arm of the first clip with a leading portion of an engagement feature of a first panel can include engaging the arm of the first clip with the leading portion of the engagement feature of one of: i) an exterior cladding panel, a solar panel, or a tread of a step.

In at least some implementations, the method can further include attaching a second clip to the first substrate, the second clip having a base, an arm and a bearing surface, the base fixable to the first substrate, a portion of the arm delineating a part of an opening along with at least one of another portion of the second clip or one or more portions of the first substrate, the other portion of the second clip or the one or more portions of the first substrate opposed across the opening from the portion of the arm which delineates the part of the opening at least when the second clip is mounted to the first substrate, when not locked in place the arm is elastically moveable between a first configuration in which the opening has a first dimension having a first size and a second configuration in which the first dimension of the opening has a second size; inserting a leading portion of an engagement feature of the other panel through the opening and in to a pocket, the pocket which is closed in three directions and open in a fourth direction toward the opening; and engaging a bearing surface of the second clip to lock the arm in place in the first configuration via a counteracting normal force that inhibits movement of the arm toward the second configuration when the bearing surface is engaged whereby the clip loosely holds the other panel.

In at least some implementations, a method can further include: attaching a second clip to the first panel before engaging the bearing surface of the first clip to lock the arm in place in the first configuration and while the first panel is loosely held by the second clip, the second clip having a base, an arm and a bearing surface, the base fixable to the first substrate, a portion of the arm delineating a part of an opening along with at least one of another portion of the second clip or one or more portions of the first substrate, the other portion of the second clip or the one or more portions of the first substrate opposed across the opening from the portion of the arm which delineates the part of the opening at least when the second clip is mounted to the first substrate, when not locked in place the arm is elastically moveable between a first configuration in which the opening has a first dimension having a first size and a second configuration in which the first dimension of the opening has a second size; and attaching the second clip to the first substrate, the second clip self-aligned and positioned on the first substrate based on the attachment to the first panel.

In at least some implementations, the above methods can further include: locking the first panel in place, for instance by engaging a portion of a second clip by the first panel or by engaging a second portion of the first clip by the first panel or by engaging a second portion of the first clip by a second panel.

In at least some implementations, a method to remove self-aligned panels from substrates includes: disengaging a first panel from an attachment structure of a second clip that is successively adjacent a first clip such that the first panel is being loosely held by the first clip and the first panel can pivot when being loosely held by the first clip and a leading portion of an engagement feature of the first panel cannot be withdrawn until an arm of the first clip is unlocked; disengaging a bearing surface of the first clip to unlock the arm of the first clip; withdrawing the leading portion of the engagement feature of the first panel out of a pocket through the opening of the first clip to allow the first dimension of the opening to return from the second size to the first size, the pocket which is closed in three directions and open in a fourth direction toward the opening; and removing the first panel, for instance from an assembly of panels.

In at least some implementations, disengaging the bearing surface of the first clip to unlock the arm of the first clip can include detaching a second panel from the attachment structure of the first clip to unlock the arm of the first clip.

In at least some implementations, disengaging the bearing surface of the first clip to unlock the arm of the first clip can include pivoting a second end of the first panel away from a substrate to which the first clip is attached by a first angular amount.

In at least some implementations, engaging an opening of the first clip with a leading portion of an engagement feature of the first panel to cause a first dimension of the opening to expand from a first size in a first configuration to a second size in a second configuration can include subsequently pivoting the distal end of the first panel away from the substrate to which the clip is attached by an additional angular amount.

In at least some implementations, withdrawing the leading portion of the engagement feature of the first panel out of a pocket through the opening of the first clip can include at least one of: further subsequently pivoting the distal end of the first panel away from the substrate to which the clip is attached by a further angular amount; and further subsequently translating the first panel away the first clip.

In at least some implementations, a panel for use with a clip having a retainment structure to attach the panel to a substrate includes: an outer surface and an inner surface connected to the outer surface by substantially perpendicular edges, the inner surface opposed from the outer surface across a thickness of the panel, the inner surface additionally having at least one engagement feature and a rigid counteracting surface, the engagement feature configured to be detachably engaged by the retainment structure of the clip, the rigid counteracting surface configured to occupy an available space (e.g., all or just a portion of available space) that otherwise allows a portion of the retainment structure of the clip to enter its second configuration once fully engaged, the rigid bearing surface constructed and positioned to produce counteracting normal force that inhibits movement of the portion of the clip toward the second configuration, to loosely attach, and subsequently detachably fix, the panel to the substrate with self-alignment of the panel with respect to one or more other panels mounted to the substrate.

In at least some implementations, the retainment structure of the clip includes an opening and the engagement feature comprises a finger extending from one of the substantially perpendicular edges and extending substantially parallel to at least one of the outer surface and inner surface of the panel, the engagement feature having a midsection, and a leading portion, the midsection having a first cross-sectional area of a first size that fits through the opening of the retainment structure of the clip when in the first configuration, the leading portion having a second cross-sectional area of a second size, the second is larger than the first size and which does not fit the opening of the retainment structure of the clip in the first configuration.

In at least some implementations, a system to loosely attach, and subsequently detachably fix, panels to substrates with self-alignment of the panels includes: a clip having a base, arm, and a flexible segment, the base fixable to a first substrate, the arm along with at least one of another portion of the clip or one or more portions of the first substrate forming a pocket sized to encompass an engagement feature of a panel, wherein a portion of the arm along with at least one of another portion of the clip or a portion of the first substrate delineates the opposing sides of the pockets opening at least when the clip is mounted to the first substrate, when not engaged with other system components the flexible segment is positioned to permit at least the arm to be elastically moveable between a first configuration in which the opening has a first dimension having a first size and a second configuration in which the first dimension of the opening has a second size, the second size larger than the first size and permits passage of the leading portion of an engagement feature of a panel, upon full engagement of at least one associated panel the available space that the arm and other portion of the clip deflect into when in the second configuration become occupied by rigid portions of a panel thereby locking the pocket in the first configuration while the panel is fully engaged.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn, are not necessarily intended to convey any information regarding the actual shape of the particular elements, and have been solely selected for ease of recognition in the drawings.

FIG. 1A is a perspective view of a system to loosely attach, and subsequently detachably fix, panels to a substrate with self-alignment of the panels according to at least one illustrated implementation, in particular showing a plurality of clips attached to a surface of a monolithic support substrate, with a plurality of panels attached to the clips, some fixed and some loosely held by the clips, the panels in a primarily parallel self-aligning arrangement.

FIG. 1B is a perspective view of a system to loosely attach, and subsequently detachably fix, panels to a substrate with self-alignment of the panels according to at least one illustrated implementation, in particular showing a plurality of clips attached to several planer but discontinuous support surfaces, the panels in a primarily parallel self-aligning arrangement.

FIG. 1C is a perspective view a system to loosely attach, and subsequently detachably fix, panels to a substrate with self-alignment of the panels according to at least one illustrated implementation, in particular showing a plurality of clips attached to several non-planer support surfaces, the panels in the form of treads and risers of a set of stairs.

FIG. 2A is a partial cross-sectional view showing a mounting component in the form of a clip, attached to a surface of a substrate via a fastener, according to a first illustrated implementation.

FIG. 2B is a partial cross-sectional view showing a mounting component in the form of a clip, attached to a surface of a substrate via a fastener, according to a second illustrated implementation.

FIG. 2C is a partial cross-sectional view showing a mounting component in the form of a clip, attached to a surface of a substrate via a fastener, according to a third illustrated implementation.

FIG. 2D is a partial cross-sectional view showing a mounting component in the form of a clip, attached to a surface of a substrate via a fastener, according to a fourth illustrated implementation.

FIG. 2E is a partial cross-sectional view showing a mounting component in the form of a clip, attached to a surface of a substrate via a fastener, according to a fifth illustrated implementation.

FIG. 2F is a partial cross-sectional view showing a mounting component in the form of a clip, attached to a surface of a substrate via a fastener, according to a sixth illustrated implementation.

FIG. 2G is a partial cross-sectional view showing a mounting component in the form of a clip, attached to a surface of a substrate via a fastener, according to a seventh illustrated implementation.

FIG. 3A is a side elevational view showing a panel according to a first illustrated implementation, the panel including an engagement feature with a leading portion to physically detachably couple a clip, for example to physically detachably couple with the clip of FIG. 2A.

FIG. 3B is a side elevational view showing a panel according to a second illustrated implementation, the panel including an engagement feature with a leading portion to physically detachably couple with a clip, for example to physically detachably couple with the clip of FIG. 2B.

FIG. 3C is a side elevational view showing a panel according to a third illustrated implementation, the panel including an engagement feature with a leading portion to physically detachably couple with a clip, for example to physically detachably couple with the clip of FIG. 2C.

FIG. 3D is a side elevational view showing a panel according to a fourth illustrated implementation, the panel including an engagement feature with a leading portion to physically detachably couple with a clip, for example to physically detachably couple with the clip of FIG. 2D.

FIG. 3E is a side elevational view showing a panel according to a fifth illustrated implementation, the panel including an engagement feature with a leading portion to physically detachably couple with a clip, for example to physically detachably couple with the clip of FIG. 2E.

FIG. 3F is a side elevational view showing a panel according to a sixth illustrated implementation, the panel including an engagement feature with a leading portion to physically detachably couple with a clip, for example to physically detachably couple with the clip of FIG. 2F.

FIG. 3G is a side elevational view showing a panel according to a seventh illustrated implementation, the panel including an engagement feature with a leading portion to physically detachably couple with a clip, for example to physically detachably couple with the clip of FIG. 2G.

FIG. 4A is a partial cross-sectional view showing an assembled system including a clip attached to a surface of a substrate via a fastener as illustrated in FIG. 2A, with an engagement feature of a first panel as illustrated in FIG. 3A inserted into a retainment structure of the clip, and a second successively adjacent panel having rigid counteracting surface engaging a bearing surface of the clip to constrict movement of an arm of the clip and thereby fix the first panel in place, according to a first illustrated implementation.

FIG. 4B is a partial cross-sectional view showing an assembled system including a clip attached to a surface of a substrate via a fastener as illustrated in FIG. 2B, with an engagement feature of a first panel as illustrated in FIG. 3B inserted into a retainment structure of the clip, and a second successively adjacent panel having a rigid counteracting surface engaging a bearing surface of the clip to constrict movement of an arm of the clip and thereby fix the first panel in place, according to a second illustrated implementation.

FIG. 4C is a partial cross-sectional view showing an assembled system including a clip attached to a surface of a substrate via a fastener as illustrated in FIG. 2C, with an engagement feature of a first panel as illustrated in FIG. 3C inserted into a retainment structure of the clip, and a rigid counteracting surface of the first panel engaging a bearing surface of the clip to constrict movement of an arm of the clip and thereby fix the first panel in place, according to a third illustrated implementation.

FIG. 4D is a partial cross-sectional view showing an assembled system including a clip attached to a surface of a substrate via a fastener as illustrated in FIG. 2D, with an engagement feature of a first panel as illustrated in FIG. 3D inserted into a retainment structure formed in part by a portion of the clip, and a second successively adjacent panel having a rigid counteracting surface engaging a bearing surface of the clip to constrict movement of an arm of the clip and thereby fix the first panel in place, according to a fourth illustrated implementation.

FIG. 4E is a partial cross-sectional view showing an assembled system including a clip attached to a surface of a substrate via a fastener as illustrated in FIG. 2E, with an engagement feature of a first panel as illustrated in FIG. 3E inserted into a retainment structure formed in part by a portion of the clip, and a second successively adjacent panel having a rigid counteracting surface engaging a bearing surface of the clip to constrict movement of an arm of the clip and thereby fix the first panel in place, according to a fifth illustrated implementation.

FIG. 4F is a partial cross-sectional view showing an assembled system including a clip attached to a surface of a substrate via a fastener as illustrated in FIG. 2F, with an engagement feature of a first panel as illustrated in FIG. 3F inserted into a retainment structure of the clip, and a second successively adjacent panel having a rigid counteracting surface engaging a bearing surface of the clip to constrict movement of an arm of the clip and thereby fix the first panel in place, according to a sixth illustrated implementation.

FIG. 4G is a partial cross-sectional view showing an assembled system including a clip attached to a surface of a substrate via a fastener as illustrated in FIG. 2G, with an engagement feature of a first panel as illustrated in FIG. 3G inserted into a retainment structure of the clip, and a second successively adjacent panel having a rigid counteracting surface engaging a bearing surface of the clip to constrict movement of an arm of the clip and thereby fix the first panel in place, according to a seventh illustrated implementation.

FIG. 5A is a partial cross-sectional view showing an assembling of a system including a clip attached to a surface of a substrate via a fastener as illustrated in FIG. 2A, with an engagement feature of a first panel as illustrated in FIG. 3A being inserted into or alternatively being withdrawn from a retainment structure of the clip, the retainment structure being forced from a first configuration (FIGS. 2A, 4A) into a second configuration (FIG. 5A), and a second successively adjacent panel having rigid counteracting surface prior to engaging a bearing surface of the clip to constrict movement of an arm of the clip and thereby fix the first panel in place, according to a first illustrated implementation.

FIG. 5B is a partial cross-sectional view showing an assembling of a system including a clip attached to a surface of a substrate via a fastener as illustrated in FIG. 2B, with an engagement feature of a first panel as illustrated in FIG. 3B inserted into or alternatively being withdrawn from a retainment structure of the clip, the retainment structure being forced from a first configuration (FIGS. 2B, 4B) into a second configuration (FIG. 5B), and a second successively adjacent panel having a rigid counteracting surface prior to engaging a bearing surface of the clip to constrict movement of an arm of the clip and thereby fix the first panel in place, according to a second illustrated implementation.

FIG. 5C is a partial cross-sectional view showing an assembling of a system including a clip attached to a surface of a substrate via a fastener as illustrated in FIG. 2C, with an engagement feature of a first panel as illustrated in FIG. 3C inserted into or alternatively being withdrawn from a retainment structure of the clip, the retainment structure being forced from a first configuration (FIGS. 2C, 4C) into a second configuration (FIG. 5C), and a rigid counteracting surface of the first panel prior to engaging a bearing surface of the clip to constrict movement of an arm of the clip and thereby fix the first panel in place, according to a third illustrated implementation.

FIG. 5D is a partial cross-sectional view showing an assembling of a system including a clip attached to a surface of a substrate via a fastener as illustrated in FIG. 2D, with an engagement feature of a first panel as illustrated in FIG. 3D inserted into or alternatively being withdrawn from a retainment structure formed in part by a portion of the clip, the retainment structure being forced from a first configuration (FIGS. 2D, 4D) into a second configuration (FIG. 5D), and a second successively adjacent panel having a rigid counteracting surface prior to engaging a bearing surface of the clip to constrict movement of an arm of the clip and thereby fix the first panel in place, according to a fourth illustrated implementation.

FIG. 5E is a partial cross-sectional view showing an assembling of a system including a clip attached to a surface of a substrate via a fastener as illustrated in FIG. 2E, with an engagement feature of a first panel as illustrated in FIG. 3E inserted into or alternatively being withdrawn from a retainment structure formed in part by a portion of the clip, the retainment structure being forced from a first configuration (FIGS. 2E, 4E) into a second configuration (FIG. 5E), and a second successively adjacent panel having a rigid counteracting surface prior to engaging a bearing surface of the clip to constrict movement of an arm of the clip and thereby fix the first panel in place, according to a fifth illustrated implementation.

FIG. 5F is a partial cross-sectional view showing an assembling of a system including a clip attached to a surface of a substrate via a fastener as illustrated in FIG. 2F, with an engagement feature of a first panel as illustrated in FIG. 3F inserted into or alternatively being withdrawn from a retainment structure of the clip, the retainment structure being forced from a first configuration (FIGS. 2F, 4F) into a second configuration (FIG. 5F), and a second successively adjacent panel having a rigid counteracting surface prior to engaging a bearing surface of the clip to constrict movement of an arm of the clip and thereby fix the first panel in place, according to a sixth illustrated implementation.

FIG. 5G is a partial cross-sectional view showing an assembling of a system including a clip attached to a surface of a substrate via a fastener as illustrated in FIG. 2G, with an engagement feature of a first panel as illustrated in FIG. 3G inserted into or alternatively being withdrawn from a retainment structure of the clip, the retainment structure being forced from a first configuration (FIGS. 2G, 4G) into a second configuration (FIG. 5G), and a second successively adjacent panel having a rigid counteracting surface prior to engaging a bearing surface of the clip to constrict movement of an arm of the clip and thereby fix the first panel in place, according to a seventh illustrated implementation.

FIG. 6 is a partial cross-sectional view showing a system including a pair of clips attached to a substrate via respective fasteners, a first panel partially removed from the clips and portions of two successively adjacent panels, illustrating how a single component can be readily removed without damaging any of the components.

### DETAILED DESCRIPTION OF THE VARIOUS IMPLEMENTATIONS OF THE INVENTION

The following Description should be read in conjunction with the accompanying drawings, it should be noted that the accompanying drawings are not drawn to scale and therefore the reader should not overly rely upon same for scaling purposes.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with construction, buildings and other structures, cladding, flooring, steps or stair treads, solar panels or photovoltaic panels and solar collectors and other types of panels, have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment,” “one implementation,” “an embodiment,” or “an implementation” means that a particular feature, structure or characteristic described in connection with the embodiment or implementation is included in at least one embodiment or one implementation. Thus, the appearances of the phrases “in one embodiment,” “in one implementation,” “in an embodiment,” “or “in one implementation” in various places throughout this specification are not necessarily all referring to the same embodiment or to the same implementation. Furthermore, the particular features, structures, or characteristics may be combined in any suitable manner in one or more embodiments or implementations.

As used in this specification and the appended claims, the singular forms “a,” “an,” and “the” include plural referents unless the content clearly dictates otherwise. Thus, for purposes of the description that follows and the appended claims, the terms “a”, “the” though referring specifically to single items are to be interpreted to mean “at least one”. Therefore, in referring for example to a panel component, a description made herein is “a panel component” or “the panel component” includes “at least one” panel component.

It should also be noted that the term “or” is generally employed in its sense including “and/or” unless the content clearly dictates otherwise.

The terms “including”, “include”, “comprises”, “comprising” and the like are intended to be open-ended terms that are minimally inclusive of the terms or elements associated with these terms.

As used in this specification and the appended claims, the terms “panel” and “panels” are used in a broad sense and includes a flat or curved component, which may or may not have rectangular, circular or oval profile, and that forms or is set into or otherwise mounted to a surface of substrate (e.g., a wall, ceiling, roof, floor, frame or a piece of framework, a piece of sheathing, a piece of dimensional lumber), and can include outdoor cladding, indoor cladding, panels or arrays of solar or photovoltaic (PV) cells, panels of other solar collectors, step or stair treads and, or step or stair risers.

The headings and Abstract of the Disclosure provided herein are for convenience only and do not interpret the scope or meaning of the embodiments.

Given the diversity of applications for modern paneling (e.g., cladding) systems, the preferred embodiment of the present invention may vary in aspect in order to better suit the specific application or installation. Regardless of aspect or application, said novel features and function of the present invention are maintained throughout all variants.

The present application is generally directed to a system 1000 (e.g., a cladding system) to loosely attach, and subsequently detachably fix, panels to substrates with self-alignment of the panels. The system 1000 can also be interchangeably referred to as an assembly. Such can, for example, be employed to cover interior and/or exterior surfaces of a building. Said system 1000 includes at least one, and typically more, mounting components, for example one or more clips 2000. Said system 1000 typically includes one, or often more, panels 3000. The system 1000 can be used to attach the panels 3000 in a hung panel arrangement, in which the panels 3000 as attached to the clips 2000 are advantageously self-aligning. The assembly of clips 2000 and panels 3000 forms an interconnected surface or surfaces, wherein each clip 2000 secures adjacent courses of panels 3000 to each other through a mating of an engagement feature 3100 (also interchangeably referred to as an engaging element) with a retainment structure 2020, where a dimension of an opening 2114 associated with the retainment structure 2020 varies between a first size in a first configuration and a second size in a second configuration, the second size sufficiently large to pass the engagement feature 3100 therethrough and the first size sufficiently small to retain the engagement feature 3100 against withdrawal, for instance in a pocket 2110 delimited at least in part by the retainment structure 2020.

When being installed, the clip 2000 can initially loosely and unsecurely attach the panel 3000, such that the panel 3000 is pivotable or rotatable relative to the substrate, the clip 2000 and, or relative to other panels (e.g., adjacent or otherwise neighboring panels) such that a leading portion of an engagement feature of the panel can be withdrawn from a retainment structure, for instance can be withdrawn via an opening of a pocket formed at least in part by the arm of the clip. An arm of the clip can then be locked to loosely and securely attach the panel 3000 so that the panel 3000 is pivotable relative to the substrate, the clip 2000 and, or other panels, but such that a leading portion of an engagement feature of the panel cannot be withdrawn from a retainment structure, for instance cannot be withdrawn via an opening of a pocket formed at least in part by the arm of the clip. Such may advantageously support the panel 3000 against a force of gravity. Such may be particularly useful to temporarily hold panels 3000, for example when installing on substrates that are angled or upside down with respect to the ground (e.g., on walls, on a ceiling, on a sloped roof). The panel 3000 can then subsequently be locked in place in an assembly such that the panel 3000 is detachably fixed in the assembly.

When being deinstalled or disassembled, the panel 3000 starts out initially locked such that the panel 3000 is fixed in the assembly. The panel 3000 is initially unlocked from the assembly or matrix, for example by detaching a portion of the panel 3000 from a successively adjacent clip. At this stage, an arm of the clip is locked and the panel 3000 is loosely and securely held by the clip 2000 (e.g., panel can pivot but an engagement feature is unable to be withdrawn from a retainment structure, for instance unable to be withdrawn through an opening of a pocket). Such may be particularly useful to temporarily hold panels 3000 for example when installing on substrates 1010 that are angled or upside down with respect to the ground (e.g., on walls, on a ceiling, on a sloped roof). An arm of the clip 2000 is then unlocked, for example by lifting an adjacent or otherwise neighboring panel or the panel 3000 itself, whereby the clip 2000 loosely and unsecurely holds the panel 3000, for instance so the panel 3000 is remains pivotable relative to the substrate, the clip 2000 and, or other panels (e.g., adjacent or otherwise neighboring panels) but a leading portion of an engagement feature of the panel 3000 is now able to be withdrawn from a retainment structure, for instance withdrawn from a pocket through an opening thereof. The panel 3000 can then be removed by withdrawing a leading portion of an engagement feature of the panel 3000 from a retainment structure, and the panel 3000 can be replaced or repaired, or a repair can be made to the underlying substrate 1010, all without damaging or destroying the panels, the clips or the underlying substrate.

As such a panel 3000 may advantageously be de-mounted and reinstalled or replaced with minimal disruption to the panel matrix (e.g., cladding matrix) or panel assembly.

The clip 2000 also features a base 2010 configured (e.g., flat bottom or substrate-facing surface) to engage and be fixedly secured to the substrate 1010 via one or more fasteners (e.g., screws, bolts and nuts, nails) and, or, via adhesive (e.g., glue, two-part epoxy) thereby fastening said panel 3000 and clip 2000 assembly to the underlying structure (e.g., substrate 1010).

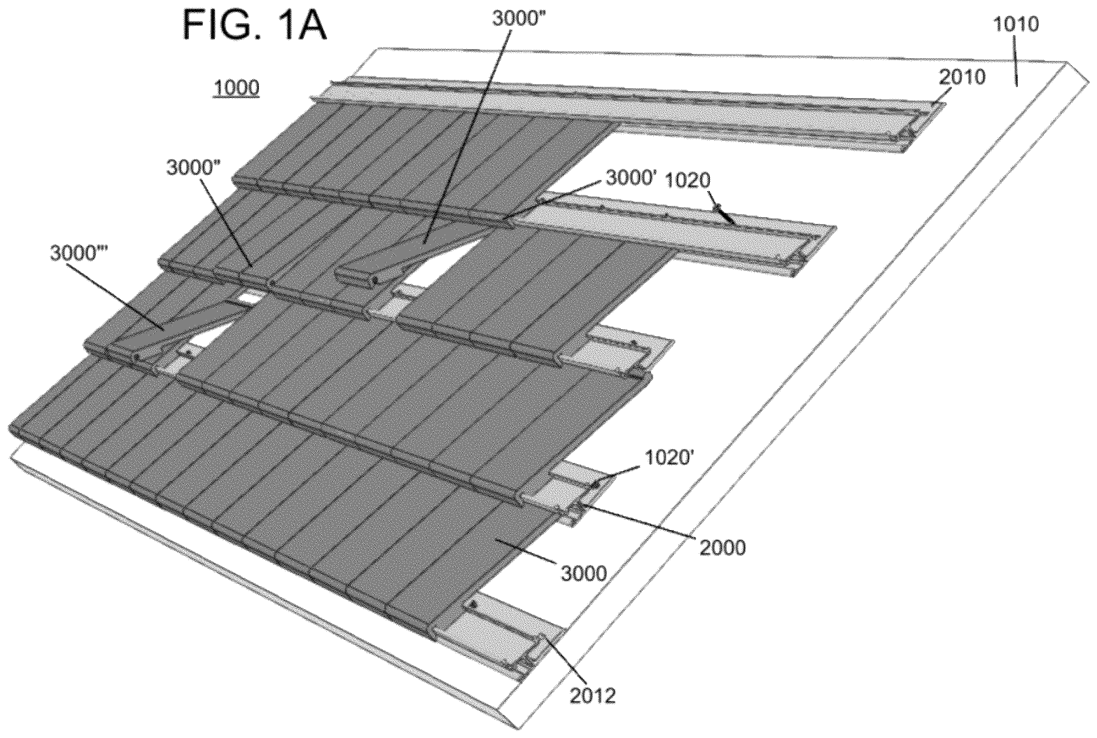

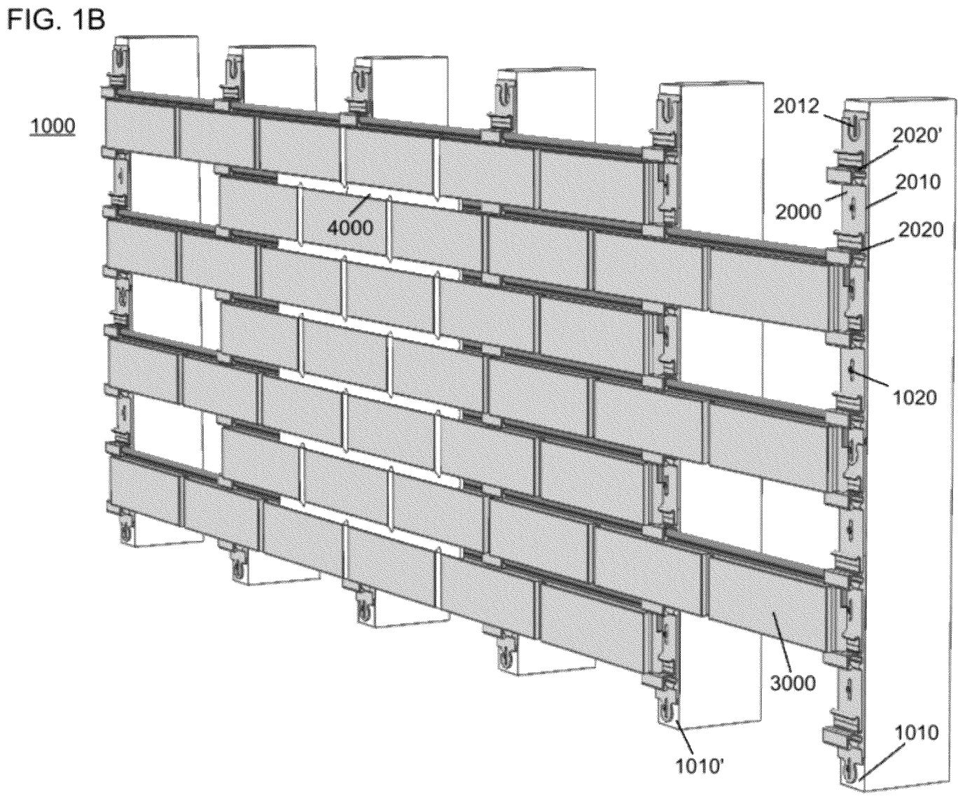

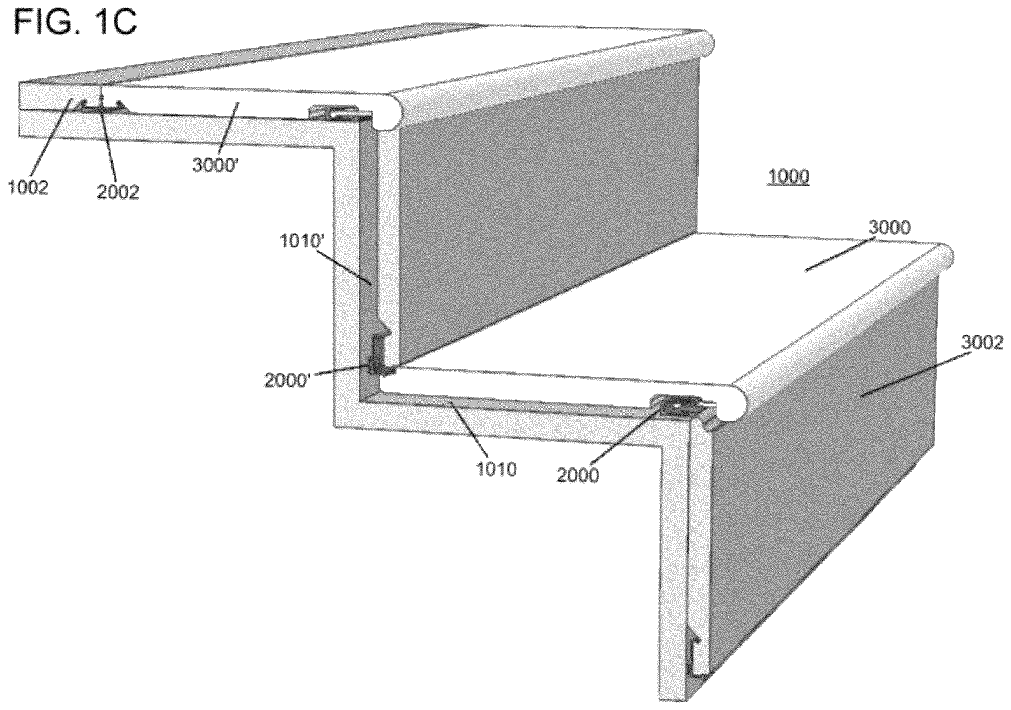

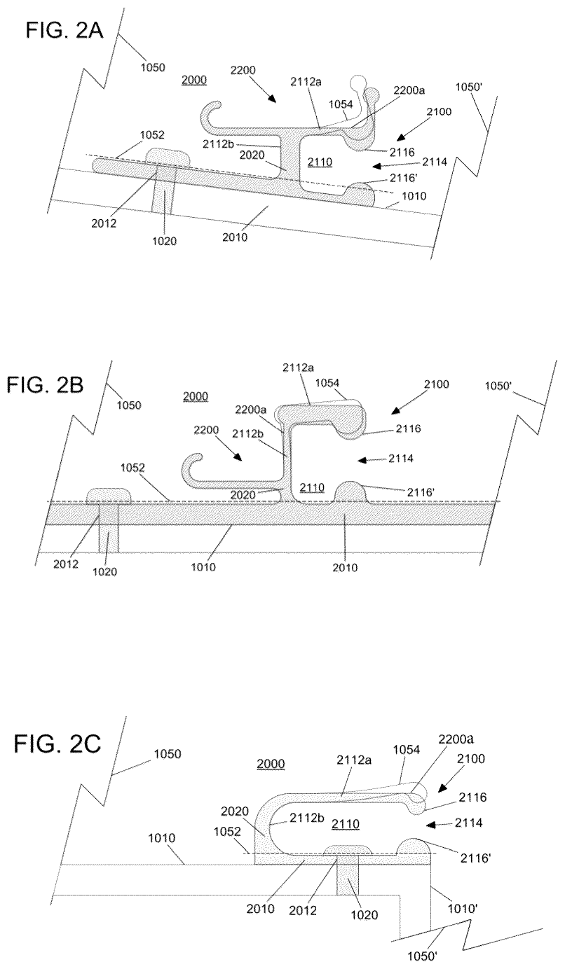

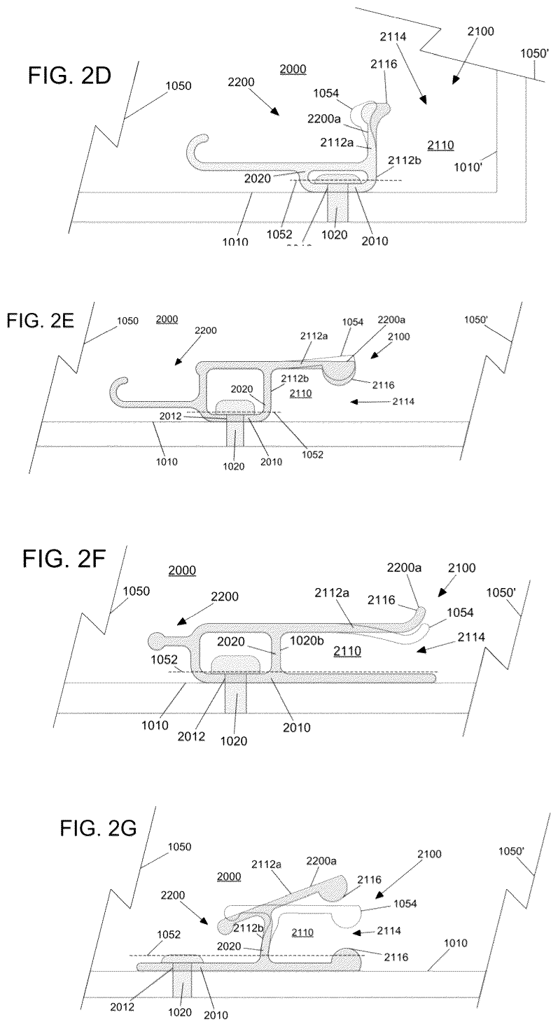

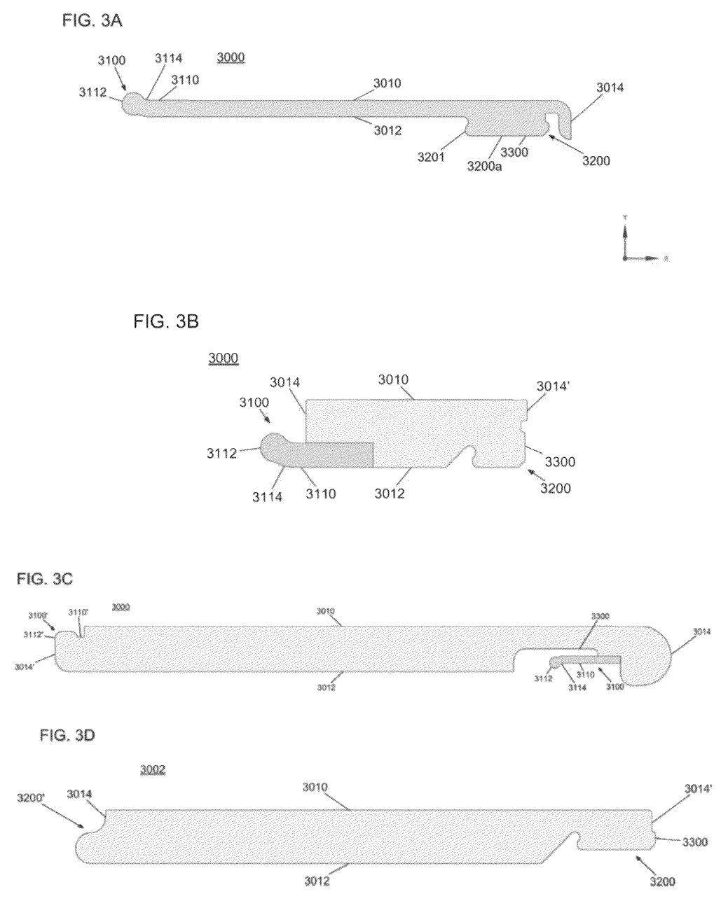

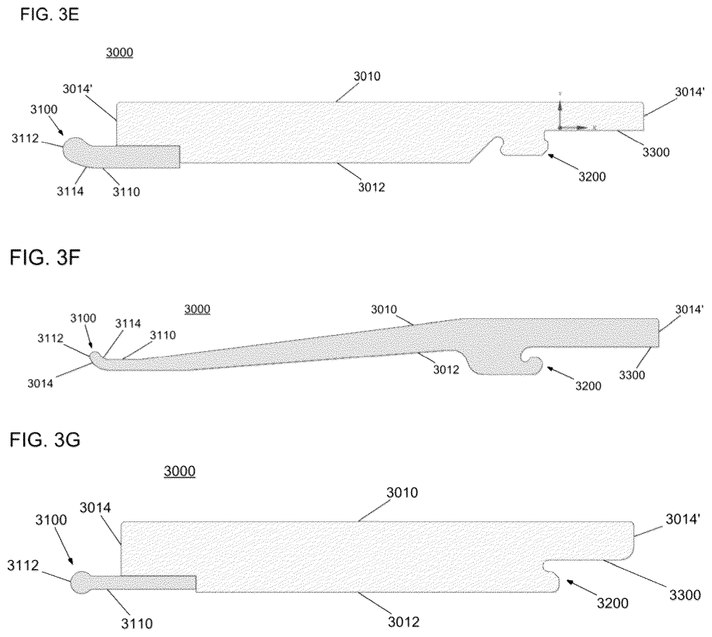

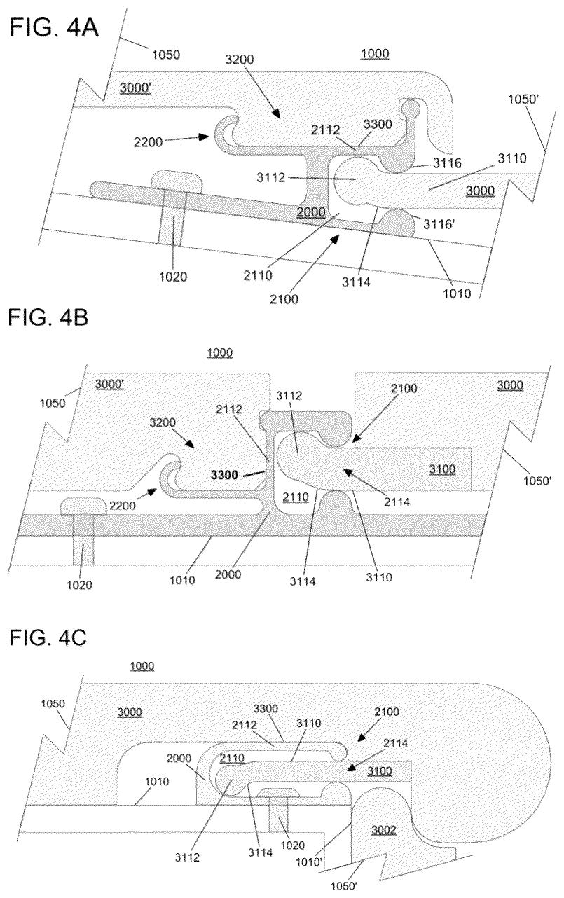

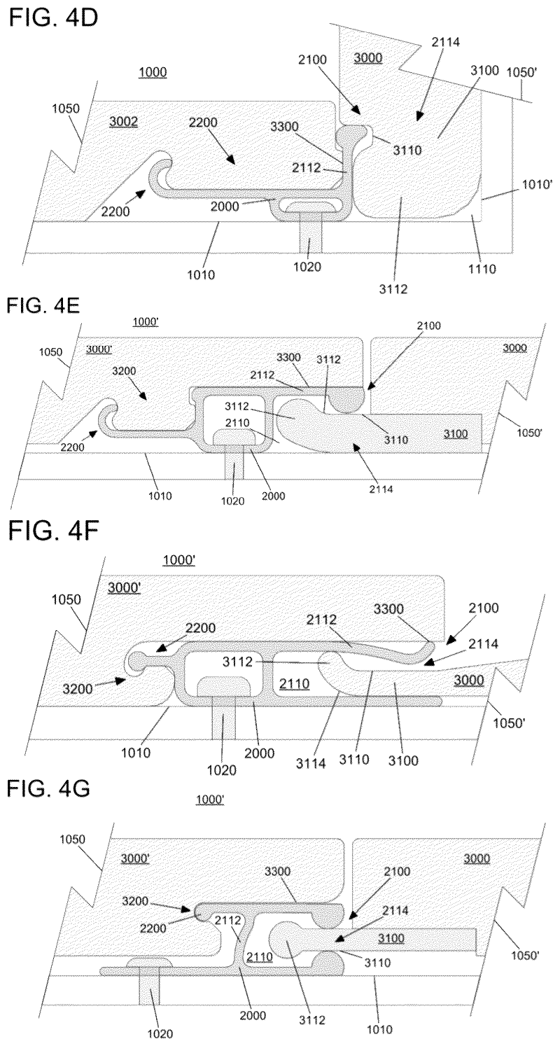

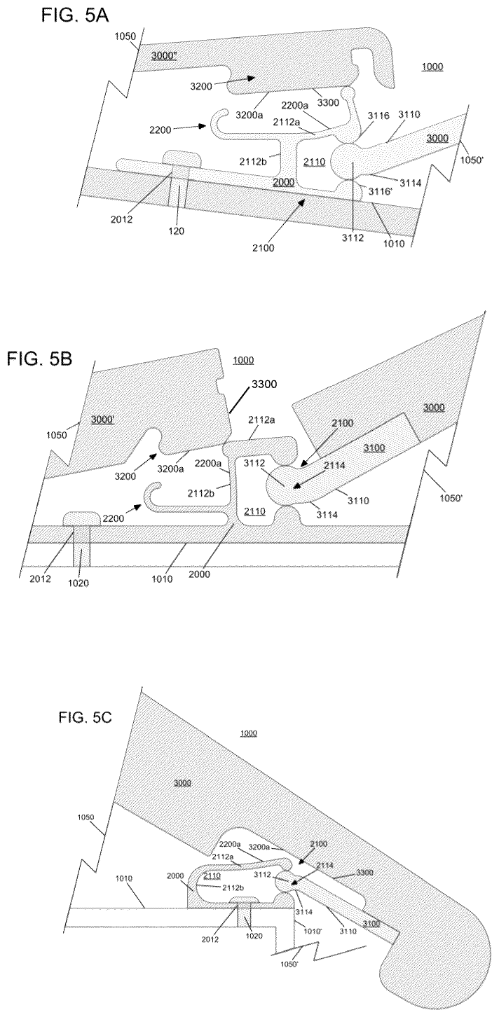

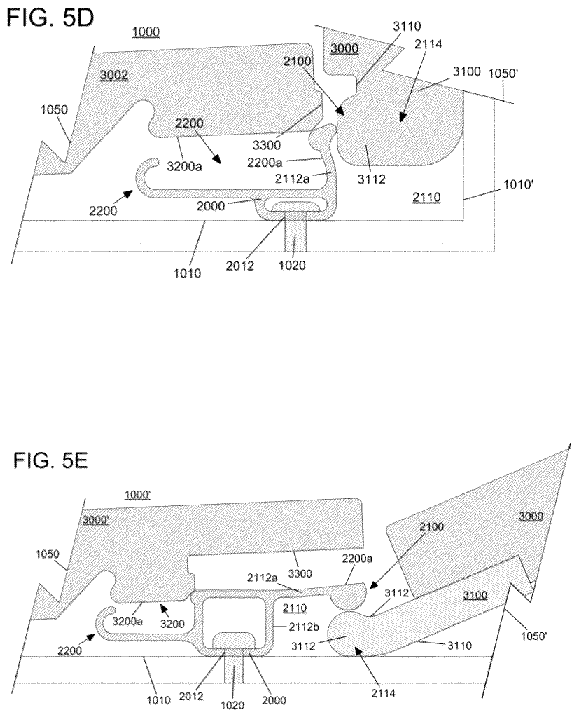

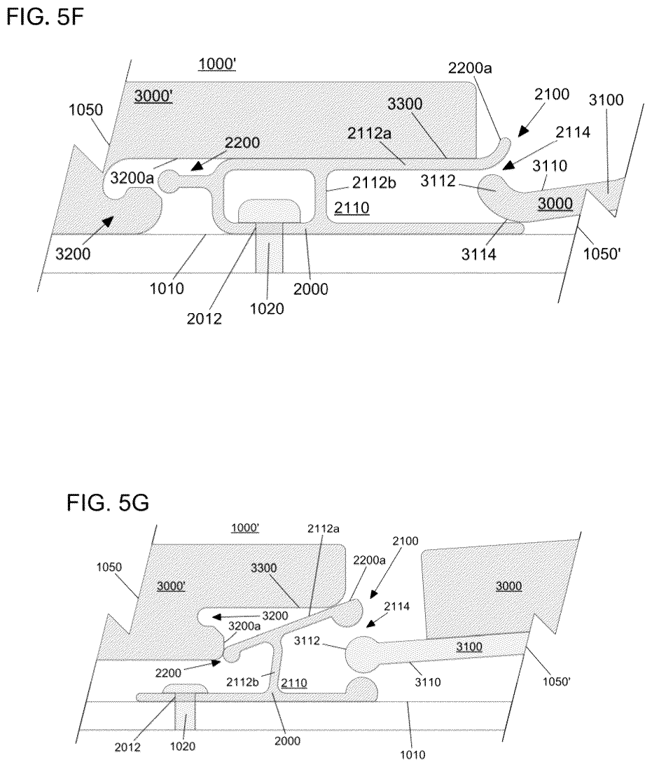

A first illustrated implementation is illustrated in FIGS. 2A, 3A, 4A and 5A, which may, for example be used in the installation or assembly of FIG. 1A. FIG. 2A shows a mounting component in the form of a clip 2000, attached to a surface of a substrate 1010 via a fastener 1020, according to the first illustrated implementation. FIG. 3A shows a first panel 3000 according to a first illustrated implementation. The first panel 3000 includes an engagement feature 3100 with a leading portion 3112 to physically detachably couple to a clip 2000, for example to physically detachably couple with the clip 2000 of FIG. 2A. FIG. 4A shows an assembled system 1000 including the clip 2000 attached to a surface of a substrate 1010 via the fastener 1020 as illustrated in FIG. 2A, with the engagement feature 3100 of a first panel 3000 as illustrated in FIG. 3A inserted into a retainment structure of the clip 2000, and a second successively adjacent panel 3002 having a rigid counteracting surface 3200a engaging a bearing surface of the clip 2000 to constrict elastic movement of an arm of the clip 2000 and thereby loosely and securely hold the first panel 3000 and subsequently fix the first panel 3000 in place, according to the first illustrated implementation. In at least some implementations, the rigid counteracting surface 3200a can be part of a complementary attachment structure 3200 which fills (e.g., partially fills, completely fills) a space into which an elastically deformable portion (e.g., arm 2112a, connection wall 2112b) of the clip 2000 would elastically move, deflect or deform into when engaged by the leading portion 3112 of the engagement feature 3100 but for the complementary attachment structure 3200 at least partially filling the space. FIG. 5A shows an assembling or a disassembling of the system 1000 including a clip 2000 attached to a surface of a substrate 1010 via a fastener 1020 as illustrated in FIG. 2A, with an engagement feature 3100 of a first panel 3000 as illustrated in FIG. 3A being inserted into or alternatively being removed from a retainment structure 2020 of the clip 2000, the retainment structure 2020 being forced from a first configuration (FIG. 2A see hatched portion, and FIG. 4A) into a second configuration (FIG. 2A see phantom line 1054, and FIG. 5A) via contact by the leading portion 3100a (e.g., enlarged portion or enlarged head) of the engagement feature 3100 (e.g., snap-fit installation or a press-fit installation), and a second successively adjacent panel 3002 having rigid counteracting surface 3200a prior to engaging a bearing surface 2200a of the clip 2000 to constrict movement of an arm 2112a of the clip 2000 and thereby loosely and securely hold the first panel 3000 and subsequently fix the first panel 3000 in place, according to the first illustrated implementation. The engagement feature 3100 may have a leading portion 3112 that engages and forces at least a portion (e.g., opening 2114) of the retainment structure 2020 from the first configuration to the second configuration, whereas the portion (e.g., opening 2114) of the retainment structure 2020 may return to the first configuration from the second configuration once the leading portion 3112 of the engagement feature 3100 passes through or by the portion. The leading portion 3112 may be rounded, curved, sloped or tapered. In at least some implementations, one or more parts of the clip 2000 may be resilient, tending or biases to return to a default state or configuration once a deforming force is removed.

A second illustrated implementation is illustrated in FIGS. 2B, 3B, 4B and 5B, which may, for example be used in the installation or assembly of FIG. 1A. FIG. 2B shows a mounting component in the form of a clip 2000, attached to a surface of a substrate 1010 via a fastener 1020, according to the second illustrated implementation. FIG. 3B shows a first panel 3000 according to the second illustrated implementation. The first panel 3000 includes an engagement feature 3100 with a leading portion 3112 to physically detachably couple with a clip 2000, for example to physically detachably couple with the clip 2000 of FIG. 2B. FIG. 4B shows an assembled system 1000 including a clip 2000 attached to a surface of a substrate 1010 via a fastener 1020 as illustrated in FIG. 2B, with an engagement feature 3100 of a first panel 3000 as illustrated in FIG. 3B inserted into a retainment structure of the clip 2000, and a second successively adjacent panel 3002 having a rigid counteracting surface 3200a engaging a bearing surface of the clip 2000 to constrict movement of an arm 2112a of the clip 2000 and thereby loosely and securely hold the first panel 3000 and subsequently fix the first panel 3000 in place, according to the second illustrated implementation. In at least some implementations, the rigid counteracting surface 3200a can be part of a complementary attachment structure 3200 which fills (e.g., partially fills, completely fills) a space into which an elastically deformable portion (e.g., arm 2112a, connection wall 2112b) of the clip 2000 arm would deform when engaged by the leading portion 3112 of the engagement feature 3100 but for the complementary attachment structure 3200 at least partially filling the space. FIG. 5B shows an assembling or a disassembling of a system 1000 including a clip 2000 attached to a surface of a substrate 1010 via a fastener 1020 as illustrated in FIG. 2B, with an engagement feature 3100 of a first panel 3000 as illustrated in FIG. 3B being inserted into or alternatively being withdrawn from a retainment structure of the clip 2000, the retainment structure being forced from a first configuration (FIG. 2B see hatched portion, and FIG. 4B) into a second configuration (FIG. 2B see phantom line 1054, and FIG. 5B) via contact by the leading portion 3100a (e.g., enlarged portion or enlarged head) of the engagement feature 3100, and showing a second successively adjacent panel 3002 having a rigid counteracting surface 3200a prior to engaging a bearing surface of the clip 2000 to constrict movement of an arm 2112a of the clip 2000 and which engagement locks the clip 2000 and thereby loosely and securely hold the first panel 3000 and subsequently fix the first panel 3000 in place, according to the second illustrated implementation. The engagement feature 3100 may have a leading portion 3112 that engages and forces at least a portion (e.g., opening) of the retainment structure from the first configuration to the second configuration, whereas the portion (e.g., opening) of the retainment structure may return to the first configuration from the second configuration once the leading portion 3112 of the engagement feature 3100 passes through or by the portion (e.g., snap-fit installation or a press-fit installation). The leading portion 3112 may be rounded, curved, sloped or tapered. In at least some implementations, one or more parts of the clip 2000 may be resilient, tending or biases to return to a default state or configuration once a deforming force is removed.

A third illustrated implementation is illustrated in FIGS. 2C, 3C, 4C and 5C, which may, for example be used in the installation or assembly of FIG. 1C. FIG. 2C shows a mounting component in the form of a clip 2000, attached to a surface of a substrate 1010 via a fastener 1020, according to the third illustrated implementation. FIG. 3C shows a first panel 3000 according to the third illustrated implementation. The first panel 3000 includes an engagement feature 3100 with a leading portion 3112 to physically detachably couple with a clip 2000, for example to physically detachably couple with the clip 2000 of FIG. 2C. FIG. 4C shows an assembled system 1000 including a clip 2000 attached to a surface of a substrate 1010 via a fastener 1020 as illustrated in FIG. 2C, with an engagement feature 3100 of a first panel 3000 as illustrated in FIG. 3C inserted into a retainment structure of the clip 2000, and a rigid counteracting surface 3200a of the first panel 3000 engaging a bearing surface of the clip 2000 to constrict movement of an arm 2112a of the clip 2000 and thereby loosely and securely hold the first panel 3000 and subsequently fix the first panel 3000 in place, according to the third illustrated implementation. In at least some implementations, the rigid counteracting surface 3200a can be part of a restricting element (also referred to as blocking structure) which fills (e.g., partially fills, completely fills) a space into which an elastically deformable portion (e.g., arm 2112a, connection wall 2112b) of the clip 2000 arm would deform when engaged by the leading portion 3112 of the engagement feature 3100 but for the complementary attachment structure 3200 at least partially filling the space. FIG. 5C shows an assembling or a disassembling of a system 1000 including a clip 2000 attached to a surface of a substrate 1010 via a fastener 1020 as illustrated in FIG. 2C, with an engagement feature 3100 of a first panel 3000 as illustrated in FIG. 3C being inserted into or alternatively being withdrawn from a retainment structure of the clip 2000, the retainment structure being forced from a first configuration (FIG. 2C see hatched portion, and FIG. 4C) into a second configuration (FIG. 2C see phantom line 1054, and FIG. 5C) via contact by the leading portion 3100a (e.g., enlarged portion or enlarged head) of the engagement feature 3100, and showing a rigid counteracting surface 3200a of the first panel 3000 prior to engaging a bearing surface of the clip 2000 to constrict movement of an arm 2112a of the clip 2000 and which engagement locks the clip 2000 and thereby loosely and securely hold the first panel 3000 and subsequently fix the first panel 3000 in place, according to the third illustrated implementation. The engagement feature 3100 may have a leading portion 3112 that engages and forces at least a portion (e.g., opening) of the retainment structure from the first configuration to the second configuration, whereas the portion (e.g., opening) of the retainment structure may return to the first configuration from the second configuration once the leading portion 3112 of the engagement feature 3100 passes through or by the portion (e.g., snap-fit installation or a press-fit installation). The leading portion 3112 may be rounded, curved, sloped or tapered. In at least some implementations, one or more parts of the clip 2000 may be resilient, tending or biases to return to a default state or configuration once a deforming force is removed.

A fourth illustrated implementation is illustrated in FIGS. 2D, 3D, 4D and 5D, which may, for example be used in the installation or assembly of FIG. 1C. FIG. 2D shows a mounting component in the form of a clip 2000, attached to a surface of a substrate 1010 via a fastener 1020, according to the fourth illustrated implementation. FIG. 3D shows a first panel 3000 according to the fourth illustrated implementation. The first panel 3000 includes an engagement feature 3100 with a leading portion 3112 to physically detachably couple with a clip 2000, for example to physically detachably couple with the clip 2000 of FIG. 2D. FIG. 4D shows an assembled system 1000 including a clip 2000 attached to a surface of a substrate 1010 via a fastener 1020 as illustrated in FIG. 2D, with an engagement feature 3100 of a first panel 3000 as illustrated in FIG. 3D inserted into a retainment structure formed in part by a portion of the clip 2000 and in part formed by one or more substrates 1010, and a second successively adjacent panel 3002 having a rigid counteracting surface 3200a engaging a bearing surface of the clip 2000 to constrict movement of an arm 2112a of the clip 2000 and thereby loosely and securely hold the first panel 3000 and subsequently fix the first panel 3000 in place, according to the fourth illustrated implementation. In at least some implementations, the rigid counteracting surface 3200a can be part of a restricting element 3300 (also referred to as blocking structure) which fills (e.g., partially fills, completely fills) a space into which an elastically deformable portion (e.g., arm 2112a, connection wall 2112b) of the clip 2000 arm would deform when engaged by the leading portion 3112 of the engagement feature 3100 but for the restricting element 3300 at least partially filling the space. FIG. 5D shows an assembling or a disassembling of a system 1000 including a clip 2000 attached to a surface of a substrate 1010 via a fastener 1020 as illustrated in FIG. 2D, with an engagement feature 3100 of a first panel 3000 as illustrated in FIG. 3D being inserted into or alternatively being withdrawn from a retainment structure formed in part by a portion of the clip 2000 and in part by the substrate 1010, the retainment structure being forced from a first configuration (FIG. 2D see hatched portion, and FIG. 4D) into a second configuration (FIG. 2D see phantom line 1054, and FIG. 5D) via contact by the leading portion 3100a (e.g., enlarged portion or enlarged head) of the engagement feature 3100, and showing a second successively adjacent panel 3002 having a rigid counteracting surface 3200a prior to engaging a bearing surface of the clip 2000 to constrict movement of an arm 2112a of the clip 2000 and which engagement locks the clip 2000 and thereby loosely and securely hold the first panel 3000 and subsequently fix the first panel 3000 in place, according to a fourth illustrated implementation. The engagement feature 3100 may have a leading portion 3112 that engages and forces at least a portion (e.g., opening) of the retainment structure from the first configuration to the second configuration, whereas the portion (e.g., opening) of the retainment structure may return to the first configuration from the second configuration once the leading portion 3112 of the engagement feature 3100 passes through or by the portion (e.g., snap-fit installation or a press-fit installation). The leading portion 3112 may be rounded, curved, sloped or tapered. In at least some implementations, one or more parts of the clip 2000 may be resilient, tending or biases to return to a default state or configuration once a deforming force is removed.

A fifth illustrated implementation is illustrated in FIGS. 2E, 3E, 4E and 5E, which may, for example be used in the installation or assembly of FIG. 1C. FIG. 2E shows a mounting component in the form of a clip 2000, attached to a surface of a substrate 1010 via a fastener 1020, according to the fifth illustrated implementation. FIG. 3E shows a first panel 3000 according to the fifth illustrated implementation. The first panel 3000 includes an engagement feature 3100 with a leading portion 3112 to physically detachably couple with a clip 2000, for example to physically detachably couple with the clip 2000 of FIG. 2E. FIG. 4E shows an assembled system 1000 including a clip 2000 attached to a surface of a substrate 1010 via a fastener 1020 as illustrated in FIG. 2E, with an engagement feature 3100 of a first panel 3000 as illustrated in FIG. 3E inserted into a retainment structure formed in part by a portion of the clip 2000 and a portion of the substrate 1010, and a second successively adjacent panel 3002 having a rigid counteracting surface 3200a engaging a bearing surface of the clip 2000 to constrict movement of an arm 2112a of the clip 2000 and thereby loosely and securely hold the first panel 3000 and subsequently fix the first panel 3000 in place, according to the fifth illustrated implementation. In at least some implementations, the rigid counteracting surface 3200a can be part of a restricting element 3300 (also referred to as blocking structure) which fills (e.g., partially fills, completely fills) a space into which an elastically deformable portion (e.g., arm 2112a, connection wall 2112b) of the clip 2000 arm would deform when engaged by the leading portion 3112 of the engagement feature 3100 but for the restricting element 3300 at least partially filling the space. FIG. 5E showing an assembling or disassembling of a system 1000 including a clip 2000 attached to a surface of a substrate 1010 via a fastener 1020 as illustrated in FIG. 2E, with an engagement feature 3100 of a first panel 3000 as illustrated in FIG. 3E being inserted into or alternatively being withdrawn from a retainment structure formed in part by a portion of the clip 2000, the retainment structure being forced from a first configuration (FIG. 2E see hatched portion, and FIG. 4E) into a second configuration (FIG. 2E see phantom line 1054, and FIG. 5E) via contact by the leading portion 3100a (e.g., enlarged portion or enlarged head) of the engagement feature 3100, and showing a second successively adjacent panel 3002 having a rigid counteracting surface 3200a prior to engaging a bearing surface of the clip 2000 to constrict movement of an arm 2112a of the clip 2000 and which engagement locks the clip 2000 and thereby loosely and securely hold the first panel 3000 and subsequently fix the first panel 3000 in place, according to the fifth illustrated implementation. The engagement feature 3100 may have a leading portion 3112 that engages and forces at least a portion (e.g., opening) of the retainment structure from the first configuration to the second configuration, whereas the portion (e.g., opening) of the retainment structure may return to the first configuration from the second configuration once the leading portion 3112 of the engagement feature 3100 passes through or by the portion (e.g., snap-fit installation or a press-fit installation). The leading portion 3112 may be rounded, curved, sloped or tapered. In at least some implementations, one or more parts of the clip 2000 may be resilient, tending or biases to return to a default state or configuration once a deforming force is removed.

A sixth illustrated implementation is illustrated in FIGS. 2F, 3F, 4F and 5F, which may, for example be used in an installation or assembly. FIG. 2F shows a mounting component in the form of a clip 2000, attached to a surface of a substrate 1010 via a fastener 1020, according to the sixth illustrated implementation. FIG. 3F shows a first panel 3000 according to the sixth illustrated implementation. The first panel 3000 includes an engagement feature 3100 with a leading portion 3112 to physically detachably couple with a clip 2000, for example to physically detachably couple with the clip 2000 of FIG. 2F. FIG. 4F shows an assembled system 1000 including a clip 2000 attached to a surface of a substrate 1010 via a fastener 1020 as illustrated in FIG. 2F, with an engagement feature 3100 of a first panel 3000 as illustrated in FIG. 3F inserted into a retainment structure of the clip 2000, and a second successively adjacent panel 3002 having a rigid counteracting surface 3200a engaging a bearing surface of the clip 2000 to elastically deform or otherwise move an arm 2112a of the clip 2000 from a second configuration (e.g., unbiased state) illustrated in FIG. 2F as hatched portion to a first configuration (e.g., biased state) illustrated in FIG. 2F as phantom line 1054 and thereby loosely and securely hold the first panel 3000 (e.g., leading portion 3112 of the engagement feature 3100 of the first panel 3000 cannot be withdrawn from retainment structure and first panel 3000 pivotable), according to the sixth illustrated implementation. In at least some implementations, the rigid counteracting surface 3200a can be part of a restricting element 3300 (also referred to as blocking structure) which fills (e.g., completely fills; partially fills) a space into which an elastically deformable portion (e.g., arm 2112a, connection wall 2112b) of the clip 2000 arm would be in if not elastically deformed or otherwise moved by the rigid counteracting surface 3200a or restricting element 3300. FIG. 5F shows an assembling or disassembling of a system 1000 including a clip 2000 attached to a surface of a substrate 1010 via a fastener 1020 as illustrated in FIG. 2F, with an engagement feature 3100 of a first panel 3000 as illustrated in FIG. 3F being inserted into or alternatively being withdrawn from a retainment structure of the clip 2000, the retainment structure being forced from a second configuration (FIGS. 2F, 4F) into a first configuration (FIGS. 2F, 5F) via contact by the rigid counteracting surface 3200a or restricting element 3300, and showing the first panel 3000 having a rigid counteracting surface 3200a prior to engaging a bearing surface of the clip 2000 to elastically deform or otherwise move arm 2112a of the clip 2000 and which engagement locks the clip 2000 and thereby loosely and securely hold the first panel 3000, wherein the first panel 3000 is subsequently fixed or locked in place in an assembly or matrix of panels, according to the sixth illustrated implementation. The engagement feature 3100 may have a leading portion 3112 that engages at least a portion (e.g., opening) of the retainment structure when in the first configuration to retain at least the leading portion 3112 of the engagement feature 3100, whereas the portion (e.g., opening) of the retainment structure may return to the second configuration from the first configuration once the rigid counteracting surface 3200a or restricting element 3300 is removed thereby allowing the leading portion 3112 of the engagement feature 3100 to pass through or by the portion 3112. The leading portion 3112 may be rounded, curved, sloped or tapered. In at least some implementations, one or more parts of the clip 2000 may be resilient, tending or biases to return to a default state or configuration once a deforming force is removed.

A seventh illustrated implementation is illustrated in FIGS. 2G, 3G, 4G and 5G, which may, for example be used in an installation or assembly. FIG. 2G shows a mounting component in the form of a clip 2000, attached to a surface of a substrate 1010 via a fastener 1020, according to the seventh illustrated implementation. FIG. 3G shows a first panel 3000 according to the seventh illustrated implementation. The first panel 3000 includes an engagement feature 3100 with a leading portion 3112 to physically detachably couple with a clip 2000, for example to physically detachably couple with the clip 2000 of FIG. 2G. FIG. 4G shows an assembled system 1000 including a clip 2000 attached to a surface of a substrate 1010 via a fastener 1020 as illustrated in FIG. 2G, with an engagement feature 3100 of a first panel 3000 as illustrated in FIG. 3G inserted into a retainment structure of the clip 2000, and a second successively adjacent panel 3002 having a rigid counteracting surface 3200a engaging a bearing surface of the clip 2000 to elastically deform or otherwise move an arm 2112a of the clip 2000 from a second configuration (e.g., unbiased state) illustrated in FIG. 2G as hatched portion to a first configuration (e.g., biased state) illustrated in FIG. 2G as phantom line 1054 and thereby loosely and securely hold the first panel 3000 (e.g., leading portion 3112 of the engagement feature 3100 of the first panel 3000 cannot be withdrawn from retainment structure and first panel 3000 pivotable), according to the seventh illustrated implementation. In at least some implementations, the rigid counteracting surface 3200a can be part of a restricting element 3300 (also referred to as blocking structure) which fills (e.g., completely fills; partially fills) a space into which an elastically deformable portion (e.g., arm 2112a, connection wall 2112b) of the clip 2000 arm would be in if not elastically deformed or otherwise moved by the rigid counteracting surface 3200a or restricting element 3300. FIG. 5G shows an assembling or disassembling of a system 1000 including a clip 2000 attached to a surface of a substrate 1010 via a fastener 1020 as illustrated in FIG. 2G, with an engagement feature 3100 of a first panel 3000 as illustrated in FIG. 3G being inserted into or alternatively being withdrawn from a retainment structure of the clip 2000, the retainment structure being forced from a second configuration (FIGS. 2G, 4G) into a first configuration (FIGS. 2G, 5G) via contact by the rigid counteracting surface 3200a or restricting element 3300, and showing a second successively adjacent panel 3002 having a rigid counteracting surface 3200a prior to engaging a bearing surface of the clip 2000 to elastically deform or otherwise move the arm 2112a of the clip 2000 and thereby loosely and securely hold the first panel 3000, wherein the first panel 3000 is subsequently fixed or locked in place in an assembly or matrix of panels, according to the seventh illustrated implementation. The engagement feature 3100 may have a leading portion 3112 that engages at least a portion (e.g., opening) of the retainment structure when in the first configuration to retain at least the leading portion 3112 of the engagement feature 3100, whereas the portion (e.g., opening) of the retainment structure may return to the second configuration from the first configuration once the rigid counteracting surface 3200a or restricting element 3300 is removed thereby allowing the leading portion 3112 of the engagement feature 3100 to pass through or by the portion 3112. The leading portion 3112 may be rounded, curved, sloped or tapered. In at least some implementations, one or more parts of the clip 2000 may be resilient, tending or biases to return to a default state or configuration once a deforming force is removed.

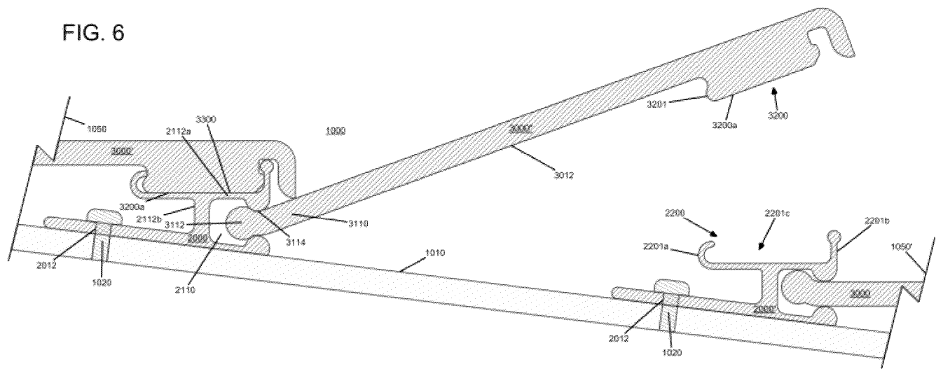

As called out in FIG. 6, in at least some implementations, the attachment structure 2200 comprises a finger 2201a of the clip 2000 and an opposed portion 2201b of the clip 2000, the opposed portion 2201b of the clip 2000 opposed from the finger 2201a to form a gap 2201c therebetween, the gap 2201c sized to securely removably receive a portion of the second panel 3000′ therein via a snap-fit interference (snapping into place) or a press-fit interference (pressing into place). The opposed portion 2201b of the clip 2000 can include a bearing surface 2200a which can be a surface of the arm 2112a of the clip 2000. The opposed portion 2201b of the clip 2000 can include a bearing surface 2200a which can be a surface of the connection wall 2112b of the clip 2000.

In some implementations, the finger 2201a of the clip 2000 can be an upstanding finger as illustrated in FIGS. 5A-5E and 6 that extends substantially perpendicular to the base 2010 and which has an arcuate profile to engage a lip 3201 of the portion (e.g., complementary attachment structure 3200) of the second panel 3000′.

In some implementations, the finger of the clip is a horizontally extending finger that extends substantially parallel with the base 2010 of the clip.

Referring to FIG. 1A, various embodiments may take the form of a first arrangement wherein the mounting component (clip 2000, seen detailed in FIG. 2A) and panels 3000 (seen detailed in FIG. 3A) of the system 1000 (e.g., cladding assembly) feature a primarily parallel arrangement where each clip 2000 adjoins two adjacent courses of panels 3000. This arrangement may be preferred in applications with substrates 10110 that provide monolithic support surfaces (e.g., wood sheathing, backer board, plywood, oriented strand board, and concrete) and also applications featuring many relatively short panels 3000 (i.e., where a length of individual panels are too short to span spacing between perpendicularly arranged structures or substrates). Referring to FIG. 1B, various embodiments may take the form of a second arrangement which may be best suited for applications featuring substrates 10110 with planer but discontinuous support surfaces of substrates 1010, 1010′ (e.g., wall studs and decking joists) and also applications requiring gravity driven processes (e.g., water drainage and, or convective ventilation). The second arrangement features mounting components (clip 2000, seen detailed in FIG. 2B) in a primarily perpendicular arrangement with the courses of panels 3000 (seen detailed in FIG. 3B). A mounting component (clip 2000) of the second arrangement may locally adjoin successive adjacent courses of panels 3000 by featuring a contiguous base 2010 with multiple distributed retaining structures 2020 and 2020′. Referring to FIG. 1C, various embodiments may take the form of a third arrangement which may be best suited for applications featuring adjoining perpendicular support surfaces of substrates 1010 and 1010′ (e.g., exterior or interior corners, overhangs, and stairs or steps). Given the specificity of this application, the system 1000 of FIG. 1C may be heterogeneous in composition incorporating various different styles or implementations of the mounting components (clips 2000, seen detailed in FIG. 2C, or clip 2000′, seen detailed in FIG. 2D) and/or different styles or implementations of the panels 3000 (seen detailed in FIG. 3C) and complementary panels 3000″ (seen detailed in FIG. 3D). The various components described herein may also be integratable with alternative systems 1002 (e.g., alternative cladding systems).

Referring to FIGS. 2A-2G, the mounting component (clip 2000) comprises the aforementioned base 2010 suitably configured to stably engage the support surface of the substrate 1010. Periodically disposed within the base 2010 are apertures 2012 (e.g., holes or slots, illustrated in detailed in FIG. 1A-1B) sized to permit the passage of conventional fasteners 1020 for the purpose of affixing the mounting component (e.g., clip 2000) to the underlying support surface of the substrate 1010. Said slots, holes or otherwise referred to as apertures 2012 and base 2010 may be configured to permit expansion and contraction of the materials of the mounting component (e.g., clip 2000).

Still referring to FIGS. 2A-2G, the mounting component (e.g., clip 2000) also comprises at least one retaining structure 2020 extending dorsally from the base 2010. Said retaining structure 2020 comprises at least one joining element (e.g., retaining element 2100 and/or attachment structure 2200). The quantity and orientation of these joining elements with respect to one another may be altered to result in variations in the arrangement of panel courses (e.g., overlapping FIG. 1A, abutting FIG. 1B, or perpendicular FIG. 1C).

Still referring to FIGS. 2A-2G, at least one aforementioned joining element (e.g., retaining element 2100 and/or attachment structure 2200) of the retaining structure 2020 of the mounting component (e.g., clip 2000) is configured to form a three sided enclosure (e.g., pocket 2110, sized to retain at least a portion (e.g., leading portion 3112, also referred to as distal end or enlarged portion or enlarged head) of an engagement feature 3100 of a panel 3000. This enclosure (e.g., pocket 2110) does not need to be formed solely by the mounting component (e.g. clip 2000) alone (as seen in FIGS. 2A-2C and 2F-2G). In some implementations, this enclosure (e.g., pocket 2110) is formed through a combination of part of the mounting component (e.g., clip 2000) and surrounding surfaces (e.g., substrate 1010, 1010′), for instance as shown in FIGS. 2D-2E. The depth of the enclosure (e.g., pocket 2110) may be formed to allow translation of the engagement feature 3100 therein even when locked, to account for an expansion and, or a contraction expected for the associated panel 3000 and the motion required to affix the remaining edges 3014 of said panel 3000 to their corresponding mounting components (e.g., clips 2000 and/or 2002 as illustrated in FIG. 1C). In any case, the pocket 2110 may be closed in three directions, and have an opening in a fourth direction.

Generally, a deformation changes a size of an opening of a pocket, and engagement by a bearing surface of a restricting element prevents the opening from allowing a leading portion of an engagement feature to be removed when an arm of the clip is locked. For example, referring to FIGS. 2A-2G, at least one portion (e.g., arm, 2112a, connection wall 2112b) that forms at least part of the three sided enclosure (e.g., pocket 2110) of the retaining element 2100 is elastically deflectable or deformable, this deformable portion wall (e.g., arm, 2112a, connection wall 2112b) may be independent of (as illustrated in FIGS. 2C, 2E, and 2F) or integral with (as illustrated in FIGS. 2A, 2B, 2D, and 2G) additional joining elements 2220 of the clip 2000. The deformation of the elastically deflectable portion (e.g., arm, 2112a, connection wall 2112b) alters a size of a dimension (e.g., inside dimension or diameter) of the opening 2114 (as illustrated by phantom line 1054) of the three sided enclosure (e.g., pocket 2110). This alteration of the size of the dimension of the opening 2114 functions as a compliant mechanism that enables the retaining element (e.g., pocket 2110) to transition between two functionally significant states or configurations, an expanded state or configuration and a constricted state or configuration that promotes or restricts the passage (e.g., withdrawal) of a corresponding portion (e.g., leading portion 3112, also referred to as distal end or enlarged portion or enlarged head) of the engagement feature 3100, respectively. The regulation of the size of the opening 2114 may be altered by the geometry of the three sided enclosure, additional appendages, interactions with other system components, or any combination of the above (i.e., protuberance 2116 also referred to as regulating feature).

Some embodiments (as seen in FIGS. 2A-2B and 2D-2G) may feature retainment structures 2020 of mounting components (e.g., clips 2000) having attachment structure 2200, also referred to as additional joining elements) to detachably attach, mount or affix, additional panels 3000 and/or 3000′ to the clips 2000. These attachment structure 2200 may be configured to provide secure detachable attachment of associated additional panels 3000 and/or 3002. The design of these attachment structures 2200 may be chosen to best fit the panel material and the specific use application. It is recommended that the method of attachment for the attachment structures 2200 be selected with detachment in mind (i.e., intentional removal) in a manner that does not result in damage or destruction to either component. It is preferred that the attachment structure features an engagement responding to either parallel or perpendicular force application.

The mounting component (e.g., clip 2000) described and illustrated herein may be formed by any relevant method known in the art and composed of durable resilient materials suitable for prolonged repeated use as a compliant mechanism under the intended service environment providing suitably consistent service properties.

Referring to FIGS. 3A-3G, panels 3000 of various implementations feature substantially rigid construction. Said panels 3000 feature an outer surface 3010 (i.e., major surface that is exposed when installed) and an opposing inner surface 3012 (i.e., major surface that is hidden when installed). These two surfaces are connected via substantially perpendicular edges 3014. The outer surface 3010 (i.e., major surface that is exposed when installed) and the opposing inner surface 3012 are opposed to one another across a thickness of the panel 3000, where the thickness may be constant or may vary along a length of width of the panel 3000. The quantity and orientation of these edges 3014 may be chosen to best meet the desired function and aesthetic of the panels.

Referring to FIGS. 3A-3C and 3E-3F, at least one panel edge 3014 has elements (i.e., engagement feature 3100) configured (e.g., sized, shaped, oriented) to engage the retaining element 2100 of the mounting component (e.g., clip 2000). The remaining edges 3014 of the panels 3000 may have elements (i.e., complementary attachment structure 3200) configured (e.g., sized, shaped, oriented), to be securely engaged by a corresponding attachment structure 2200 of a mounting component (e.g., clip 2000), other panels (e.g., adjacent panel 3002 within a course) and/or an alternative complementary system 1002. Said elements (i.e., engagement feature 3100 and/or complementary attachment structure 3200) can be formed from the panel 3000 (as seen in FIGS. 3A and 3F) or formed separately and securely affixed to panel 3000 (as seen in FIGS. 3B-3E and 3G).

Panels 3000, 3002 may in some instances be identical to one another in at least size and profile, or even in surface textures or other ornamentation. One, more or all panels 3000, 3002 may in some instances be different from one another in at least surface textures or other ornamentation, and optionally in size and profile, and, or functional aspects.

Still referring to FIGS. 3A-3C and 3E-3F, the engagement feature 3100 may be configured (e.g., sized, shaped, oriented) to have a protruding portion (e.g., finger, tongue) extending in a substantially parallel manner (in respect to the outer surface 3010 and inner surface 3012 of said panel 3000). The engagement feature 3100 has a midsection 3110 having a primarily uniform cross-section and a leading portion 3112 (e.g., distal end, enlarged head) presenting a larger functional cross-section in a given orientation. This increased functional cross-section may be the result of shape and/or orientation.

Referring to FIGS. 4A-4G, said midsection 3110 of the engagement feature 3100 is sized to fit through the opening 2114 of the three sided enclosure (e.g., pocket 2110) of a retaining element 2100 when the deformable portion (e.g., arm 2112a, connection wall 2112b) is in its un-constricted, dilated or expanded state or configuration and when the deformable portion (e.g., arm 2112a, connection wall 2112b) is in its constricted, un-dilated or unexpanded state or configuration. The overall length of said midsection 3110 permits the entire leading portion 3112 (e.g., distal end) to be inserted past the opening 2114 of the three sided enclosure (e.g., pocket 2110) and remain contained within the retaining element's enclosure (e.g. pocket 2110) while in service.

Said leading portion 3112 of the engagement feature 3100 is sized and/or shaped or oriented such that its functional cross-section may be passed through the opening 2114 of the three sided enclosure (e.g. pocket 2110) when the retaining element 2100 is in its expanded state (as seen in FIGS. 4A-4G) while exceeding said opening 2114 size in the constricted state (as seen in FIGS. 5A-5G). The leading portion 3112 geometry should have a configuration that enables it to be entirely encompassed by the retaining element 2100 in its constricted state (as seen in FIGS. 4A-4G).

In some implementations (as seen in FIGS. 3A-3F) the midsection 3110 of the engagement feature 3100 features a non-linear geometry where in said midsection 3114 transitions from extending linearly to curving or angling as it approaches said distal leading portion 3112, offsetting the cross-sectional geometrical center of the leading portion 3112 from the cross-sectional centerline of a linearly extending portion of the midsection 3110. The non-linear portion of the midsection 3114 of the engagement feature 3100 of the panel 3000 as seen in some aspects advantageously permits the rotation or pivoting of panels 3000″ (as seen in FIGS. 1A and 6), out of plane of the assembled matrix of the system 1000, while the leading portion of their engagement feature 3100 is still contained within the retaining element 2100 without exerting undue stress or torque on the mounting component (e.g., clip 2000). Said non-linear portion of the midsection 3114 of the first engagement feature 3100 also serves to improve retention of the panel 3000 by providing a functionally enlarged cross-section when removal of the engagement feature 3100 from the retaining element 2100 is attempted in certain orientations.

Referring to FIGS. 3A-3G, panel components 3000 and/or 3002 of the described embodiments and implementations can feature at least one restricting element 3300 that is positioned to directly or indirectly interact with an elastically deflectable portion (e.g., arm 2112a, connection wall 2112b) of a retaining element 2100 of a mounting component (e.g. clip 2000) once said panel 3000 and/or 3002 is engaged (as seen in FIGS. 4A-4G). Said restricting element/elements 3300 may be an integral component of an additional joining element (e.g., complementary attachment structure 3200, as seen in FIGS. 3A, 3B, and 3D) or a separate feature of a panel 3000 (as seen in FIGS. 3C, 3E, and 3F) depending on the configuration and orientation of the chosen embodiment or implementation.

Referring to FIGS. 4A-4G, the restricting element 3300 comprises at least one surface configured to directly or indirectly interact with the at least one elastically deformable portion (e.g., arm 2112a, connection wall 2112b) of the retaining element 2100 of the mounting component (e.g., clip 2000) when in its constricted state or configuration. Said surface/surfaces of the restricting element 3300 features suitably rigid construction capable of exerting a normal force that counters the forces needed to alter the retaining element 2100 into its expanded state or configuration, thereby restraining deflection of the portion (e.g., arm 2112a, connection deformable wall 2112b) of the retaining element 2100 of the mounting component (e.g., clip 2000) while the restricting element's associated panel 3000 and/or 3002 is engaged.

In some implementations, the restricting element 3300 and/or the retaining element 2100 may be configured to exert additional force on the at least one elastically deformable portion (e.g., arm 2112a, connection wall 2112b) of the mounting component (e.g., clip 2000) that would exceed the minimum force needed to counteract a state shift of the retaining element 2100. This would result in an increased clamping force being exerted on the midsection 3110 of an engagement feature 3100 a portion of which is contained within the retaining element 2100 when said restricting element's 3300 associated panel 3000 and/or 3002 is engaged. This increased clamping force aids in reducing panel rattling in applications with high exposure to vibration.

Assembly of said system 1000 may be undergone by either a staged assembly (i.e., orientating and pre attaching the mounting components (e.g., clips 2000) to the support surface of the substrate 1010 prior to the addition of panels 3000) or a progressive assembly (i.e., corresponding clips 2000 are attached with each successive row of panels 3000) depending on chosen implementations and/or installer preference. In either aspect, there is provided a method for forming a system 1000 onto a support surface of a substrate 1010.

A method of installation can, for example, include: inserting an engagement feature 3100 of a first panel 3000 (denoted as: first panel) into the retaining element 2100 of a mounting component (e.g., clip 2000) (denoted as: first retaining element) by placing the enlarged leading portion 3112 of the engagement feature 3100 of said first panel 3000 against an opening 2114 of the first retaining element 2100 and applying a force perpendicular to the axes of alignment, as to force the engagement feature 3100 and the retaining element 2100 together. Through this process the first panel 3000 should be oriented to present the minimal possible cross section of the enlarged leading portion 3112 to reduce the force required (as seen in FIGS. 5A-5G).

Referring to FIGS. 5A-5G, in some implementations (as illustrated in FIGS. 5F and 5G) a neutral or default geometry (e.g., when not subjected to force applied via another component) of the retaining element 2100 may be in the expanded state or configuration. In other embodiments (as seen in FIGS. 5A-5E), the leading cross sectional geometry of the enlarged leading portion 3112 of the engagement feature 3100 transposes a portion of the applied force to a transverse “outward” force on the retaining element 2100 causing the deflection of the elastically deflectable or deformable portion (e.g., arm 2112a, connection wall 2112b), resulting in the widening of the opening 2114 to reach the expanded state or configuration. The expanded state or configuration permits the passage of the enlarged leading portion 3112 of the engagement feature 3100 into the enclosure (e.g., pocket 2110) while the midsection 3110 of the engagement feature 3100 extends through the opening 2114.

Depending on the implementation of the present invention, the first mounting component (e.g., clip 2000) may have already been affixed to the support surface of a substrate 1010 (e.g., staged assembly). In implementations where this is not the case (e.g., progressive assembly) the clip 2000 may be affixed at this time in the installation process.

In order to incorporate the components into an assembled system 1000 (e.g., cladding matrix), adjacent components which may include any or all of the following mounting components (e.g., clips 2000), panels 3000, and/or complementary panels 3002 are affixed using corresponding attachment structure 2200 of the clips 2000 and/or complementary attachment structure 3200 of the panels 3000. The manner in which this occurs is heavily dependent on the chosen implementation. In at least some implementations, the engagement of aforementioned associated component places a restricting element 3300 in an orientation that inhibits the elastically deflectable or deformable portion (e.g., arm 2112a, connection wall 2112b) of the first retaining element 2100 from entering the expanded state or configuration, functionally increasing the force required to remove the leading portion 3112 of the engagement feature 3100 of the first panel component 3000 from the first retaining element 2100 (as seen in FIGS. 4A-4G).

The system 1000 of the present invention is designed to exhibit the following functionality. There is provided a method for Individual panels 3000 to be partly and/or fully removed from the system 1000 with minimal local disturbance of the panel matrix.

Referring to FIGS. 1A and 6, in order to partly remove a first panel 3000 from the system 1000 (e.g., completed system or completed matrix), additional joining elements (e.g., complementary attachment structure 3200) of the first panel 3000 are disengaged from their corresponding additional joining elements (e.g., attachment structure 2200) on surrounding components (e.g., clips 2000), the method and process of disengagement is heavily dependent on the chosen implementation of the additional joining elements (e.g., attachment structure 2200 and complementary attachment structure 3200). Upon disengagement of additional joining elements (e.g., attachment structure 2200 and complementary attachment structure 3200), the first panel 3000 is still loosely adjoined to the larger system 1000 through the retention of its engagement feature 3100 within the associated retaining element 2100 of a mounting component (e.g., clip 2000). This partly removed panel 3000″ remains securely attached to the system 1000 as long as the corresponding restricting element 3300 remains in place with respect to the aforementioned retaining element's 2100 elastically deflectable or deformable portion (e.g., arm 2112a, connection wall 2112b). In some implementations of the present invention (e.g., panels 3000 have an engagement feature 3100 with a curved or angled or bent portion of their midsection 3114) this partly removed panel component 3000″ may be rotated out of plane with the remainder of the matrix of panels permitting access to the inner surface 3012 of the panel 3000″ and the underlying support surface substrate 1010 (as seen in FIGS. 1A and 6). In particular, a bend or curve in the engagement feature 3100 is spaced inwardly of and proximate the leading portion 3112 and advantageously increases a range of angular motion of the engagement feature 3100 when the arm is not locked in place and the first panel 3000 is loosely retained.

In order to fully remove a first panel 3000 from the completed matrix of the system 1000, complementary attachment structure 3200 of the first panel 3000 are disengaged from their corresponding additional joining elements (e.g., attachment structure 2200) on surrounding components (e.g., clips 2000), as in the above partial removal process. In addition, the restricting element 3300 associated with the retaining element 2100 encompassing the leading portion 3112 of the engagement feature 3100 of said first panel 3000 is disengaged freeing the retaining element's 2100 elastically deflectable or deformable portion (e.g., arm 2112a, connection wall 2112b) to enter the expanded state or configuration, whether this is achieved through an alteration in the orientation of the first panel 3000 itself (as seen in FIG. 5C) and/or via the partial removal of adjacent component/components (e.g., neighboring or successively adjacent panels 3000′, as illustrated in FIGS. 5A-5B and 5D-5G) is determined by the chosen implementation of the present invention. Once the restricting element 3300 is disengaged, the engagement feature 3100 of the first panel 3000 may be removed from its associated retaining element 2100, fully removing the first panel 3000 from the matrix of the system 1000 (e.g., cladding system, as seen in FIGS. 1A and 5A-5G).

To replace a fully removed panel 3000 of an assembled system 1000, one frees the unoccupied segment of the retaining element 2100 of a mounting component (e.g., clip 2000) from its corresponding restricting element 3300 if necessary, thereby permitting said retaining element 2100 to enter its expanded state or configuration. One then aligns and engages a engagement feature 3100 of the replacement panel 3000″ with the unoccupied segment of the retaining element 2100 similar to a staged assembly, described above. Once the engaging feature 3100 and the retaining element 2100 are joined, the corresponding restricting element 3300 may be re-engaged, locking the retaining element 2100 in its constricted state or configuration and securing the replacement panel 3000′″ to the matrix of the system 1000. One completes the installation of the replacement panel 3000″ by connecting remaining corresponding complementary attachment structure 3200 and attachment structure 2200 with their intended components.

As such, the present invention discloses a system 1000 (e.g., hung panel cladding system) that features a reversible dynamic latching system with the secure attachment (i.e., lock) of a unidirectional fastener, yet which can be disassembled without damage to the panels or clips. Advantageously, the herein described system enables demountability of individual panels making it easy to remove, repair, replace, and reuse said components as well as alter building aesthetics.

U.S. Provisional Patent Application No. 63/554,567, filed Feb. 16, 2024, to which the present application claims priority, is hereby incorporated herein by reference in its entirety.

The various embodiments described above can be combined to provide further embodiments. Aspects of the embodiments can be modified, if necessary, to employ systems, circuits and concepts of the various patents, applications and publications identified herein to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

### PARTS LIST FOR FIGS. 1-6

1000 system (also referred to as assembly, cladding system, cladding assembly or cladding matrix)
1002 complementary system (also referred to as complementary cladding system, complementary cladding assembly or complementary cladding matrix)
1010, 1010′ substrate (also referred to as support surface, e.g., a piece of plywood, oriented strand board, dimensional lumber wood sheathing, backer board, metal stud, metal framing, and concrete)
1020 fasteners (also referred to as hardware fasteners, e.g., screws, nuts and bolts, nails, rivets)
1050 break lines
1052 phantom line delineating base from retaining portion
1054 phantom line depicting the retaining element alternate functionally significant state
2000 clip (also referred to as mounting component)
2002 complementary clip (also referred to as complementary mounting component)
2010 base of clip (also referred to as base portion)
2012 holes or slots, collectively apertures
2020, 2020′ retainment structure (also referred to as retaining portion)
2100 retaining element (also referred to as joining element)
2110 pocket (also referred to as enclosure)
2112a arm (also referred to elastically deflectable arm or wall)
2112b connection wall (also referred to as elastically deflectable wall)
2114 opening of pocket (also referred to as dynamic opening)
2116 protuberance (also referred to as regulating feature)
2200 attachment structure of clip (also referred to as additional joining element of clip or of mounting components)
2200a bearing surface of clip
2201a finger of attachment structure of clip
2201b opposed portion of attachment structure of clip
2201c gap between finger and opposed portion
3000, 3000″ panel (e.g., exterior cladding panels, interior cladding, solar photovoltaic panels, solar collector panels, step or stairs treads or risers)
3002 successively adjacent panel (also referred to as neighboring panel or complementary panel)
3010 outer surface (e.g., surface of panel that is exposed when installed, also referred to as exposed surface)
3012 inner surface (e.g., surface of panel that is hidden when installed, also referred to as hidden surface)
3014 edge of panel
3100 engagement feature (also referred to as engaging element or engagement tongue)
3110 midsection of engagement feature
3112 leading portion of engagement feature (also referred to as distal end or enlarged portion or enlarged head)
3114 non-linear portion of the midsection of engagement feature
3200 complementary attachment structure of panel (also referred to additional joining element of panel components)
3200a rigid counteracting surface of panel
3201 lip of complementary attachment portion
3300 restricting element (also referred to as blocking structure)
4000 sealing compound

1. A system to loosely attach, and subsequently detachably fix, panels to substrates with self-alignment of the panels, the system comprising:
a clip having a base, an arm and a bearing surface, the base fixable to a first substrate, a portion of the arm delineates a part of an opening of a pocket along with at least one of another portion of the clip or one or more portions of the first substrate, the other portion of the clip or the one or more portions of the first substrate opposed across the opening from the portion of the arm which delineates the part of the opening at least when the clip is mounted to the first substrate, when the arm is not locked in place the arm is elastically moveable between a first configuration in which the opening has a first dimension having a first size and a second configuration in which the first dimension of the opening has a second size, the second size larger than the first size, and wherein the bearing surface locks the arm in place in the first configuration via a counteracting normal force that inhibits movement of the arm toward the second configuration when the bearing surface is engaged and prevents withdrawal of a leading portion of an engagement feature from the pocket through the opening, wherein before the bearing surface is engaged the arm is free to pivot in two directions, and wherein the clip loosely retains the first panel with the leading portion of the engagement feature received in the pocket and the first panel pivotable with respect to the clip until the first panel is locked in place.

2. The system of claim 1 wherein the clip further includes a connection wall, the connection wall which connects the arm to the base.

3. The system of claim 2 wherein the base, the connection wall and the arm form the pocket that is closed in three directions and is open in a fourth direction toward the opening.

4. The system of claim 3 wherein the base has a protuberance and the arm has a protuberance, the protuberance of the arm opposed across the opening from the protuberance of the base.

5. The system of claim 2 wherein the connection wall and the arm and the portion of the first substrate form a pocket that is closed in three directions and is open in a direction of the opening.

6. The system of claim 5 wherein the arm has a protuberance, the protuberance of the arm opposed across the opening from the portion of the first substrate.

7. The system of claim 2 wherein the arm, the portion of the first substrate, and another portion of the first substrate form a pocket that is closed in three directions and is open in a forth direction toward the opening.

8. The system of claim 7 wherein the arm has a protuberance, the protuberance of the arm opposed across the opening from the other portion of the first substrate.

9. The system of claim 2 wherein the arm is elastically deformable when the arm is not locked in place.

10. The system of claim 2 wherein the connection wall is elastically deformable when the arm is not locked in place.

11. The system of claim 2 wherein the clip further includes an attachment structure sized to securely receive a portion of a second panel, the clip which removably secures the second panel to the clip via the attachment structure.

12. The system of claim 11 wherein the attachment structure comprises a finger of the clip and an opposed portion of the clip, the opposed portion of the clip opposed from the finger to form a gap therebetween, the gap sized to securely removably receive a portion of the second panel therein via a snap-fit interference.

13. The system of claim 12 wherein the opposed portion of the clip comprises the bearing surface which is a surface of the arm of the clip.

14. The system of claim 12 wherein the opposed portion of the clip comprises the bearing surface which is a surface of the connection wall of the clip.

15. The system of claim 12 wherein the finger of the clip is an upstanding finger that that extends substantially perpendicular to the base and which has an arcuate profile to engage a lip of the portion of the second panel.

16. The system of claim 12 wherein the finger of the clip is a horizontally extending finger that extends substantially parallel with the base of the clip.

17. The system of claim 1 wherein the leading portion of the engagement feature has a dimension that corresponds to the first dimension, a size of the dimension of the leading portion of the engagement feature is larger than the first size of the first dimension of the opening, and wherein the arm moves from the first configuration to the second configuration to receive the leading portion of the engagement feature through the opening and then returns to the first configuration to loosely retain the first panel until the first panel is locked in place via attachment of a second panel to the clip.

18. The system of claim 17 wherein the engagement feature extends from the first panel.

19. The system of claim 18, further comprising: the first panel and the second panel, the second panel identical to the first panel in shape and size, the first and the second panels comprising one of: i) a pair of exterior cladding panels, ii) a pair of interior cladding panels, iii) a pair of solar panels, or iv) a pair of step treads or risers.

20. The system of claim 18 wherein the engagement feature includes a bend or curve spaced inwardly of and proximate the leading portion that increases a range of angular motion of the engagement feature when the first panel is not locked in place.

21. The system of claim 1 wherein the base has at least one aperture sized to receive a fastener to secure the clip to the first substrate, and the first substrate comprises one of: i) a piece of dimensional lumber, ii) a piece of sheathing, iii) a metal stud, or iv) a piece of a framework.

22. The system of claim 1, further comprising: an adhesive that secures the clip to the first substrate.

23. The system of claim 1 wherein the bearing surface locks the arm in place in the first configuration when the bearing surface is engaged by a portion of a second panel.

24. The system of claim 1 wherein the bearing surface locks the arm in place in the first configuration when the bearing surface is engaged by a surface of the first panel.

25. The system of claim 1 wherein at least one inside dimension of the pocket is larger than the leading portion of the engagement feature.

26. A method to loosely attach, and subsequently detachably fix, panels to substrates with self-alignment of the panels, the method comprising:
attaching a first clip to a first substrate, the first clip having a base, an arm and a bearing surface, the base fixable to the first substrate, a portion of the arm of the first clip delineating a part of an opening along with at least one of another portion of the first clip or one or more portions of the first substrate, the other portion of the first clip or the one or more portions of the first substrate opposed across the opening from the portion of the arm which delineates the part of the opening at least when the first clip is mounted to the first substrate, when not locked in place the arm is elastically moveable between a first configuration in which the opening has a first dimension having a first size and a second configuration in which the first dimension of the opening has a second size;
inserting a leading portion of an engagement feature of a first panel through the opening and in to a pocket, the pocket which is closed in three directions and open in a fourth direction toward the opening and the arm remaining unlocked and movable in at least one of two opposed directions until the arm of the first clip is locked in place; and
engaging a bearing surface of the first clip to lock the arm of the first clip in place in the first configuration via a counteracting normal force that inhibits movement of the arm of the first clip toward the second configuration when the bearing surface is engaged whereby the first clip loosely and securely holds the first panel with the first panel able to pivot with respect to the first clip and, or the substrate but the first panel not able to be withdrawn from the first clip.

27.-34. (canceled)

35. A method to remove self-aligned panels from substrates, the method comprising:
disengaging a first panel from an attachment structure of a second clip that is successively adjacent a first clip such that the first panel is being loosely and securely held by the first clip and the first panel can pivot when being loosely and securely held by the first clip and a leading portion of an engagement feature of the first panel cannot be withdrawn until an arm of the first clip is unlocked;
disengaging a bearing surface of the first clip to unlock the arm of the first clip such that the first panel is being loosely held by the first clip;
withdrawing the leading portion of the engagement feature of the first panel out of a pocket through an opening of the first clip, the pocket which is closed in three directions and open in a fourth direction toward the opening, such that the first panel is not held by the first clip; and
removing the first panel after the first clip has been unlocked.

36.-42. (canceled)
